(19) United States
(12) Patent Application Publication
(10) Pub. No.: US 2022/0116987 A1
(43) Pub. Date: Apr. 14, 2022

(54) METHODS AND APPARATUSES FOR HANDLING UPLINK (RE)TRANSMISSION IN UNLICENSED AND CONTROLLED ENVIRONMENT

(71) Applicant: FG Innovation Company Limited, Tuen Mun (HK)

(72) Inventors: HENG-LI CHIN, Taipei (TW); CHIA-HUNG WEI, Taipei (TW)

(21) Appl. No.: 17/500,255

(22) Filed: Oct. 13, 2021

Related U.S. Application Data
(60) Provisional application No. 63/091,244, filed on Oct. 13, 2020.

(51) Int. Cl. H04W 72/14; H04W 72/12; H04L 1/18; H04W 80/02

(52) U.S. Cl. CPC H04W 72/14; H04W 80/02; H04L 1/1819; H04W 72/1268

(57) ABSTRACT

A user equipment (UE) includes one or more non-transitory computer-readable media containing computer-executable instructions embodied therein, and at least one processor coupled to the one or more non-transitory computer-readable media. The at least one processor is configured to execute the computer-executable instructions to determine whether a logic channel (LCH)-based prioritization indication is configured, and when the LCH-based prioritization indication is configured, select a Hybrid Automatic Repeat Request (HARQ) process identifier (ID) of the CG PUSCH based on a priority of the HARQ process ID.

### CROSS-REFERENCE TO RELATED APPLICATION(S)

The present disclosure claims the benefit of and priority of provisional U.S. Patent Application Ser. No. 63/091,244, filed on Oct. 13, 2020, entitled “Method and Apparatus to Handle Uplink Transmission in Unlicensed and Controlled Environment” (“the '244 provisional”). The disclosure of the '244 provisional is hereby incorporated fully by reference into the present disclosure for all purposes.

### FIELD

The present disclosure is related to wireless communication, and more particularly, to methods and apparatuses for handling uplink (re)transmission in an unlicensed and controlled environment.

### BACKGROUND

New Radio (NR)-based access to unlicensed spectrum has been agreed by the 3rd Generation Partnership Project (3GPP) as one of the Work Items (WIs) for Release-16. This WI specifies NR enhancements for a single global solution framework for access to unlicensed spectrum which enables operations of NR in the unlicensed bands (e.g., 5 GHz and 6 GHz bands) taking into account of regional regulatory requirements. The NR-Unlicensed (NR-U) design should enable fair coexistence between already deployed Wireless-Fidelity (Wi-Fi) generations and NR-U, between NR-U and Long Term Evolution-License-Assisted Access (LTE-LAA), between different NR-U systems, etc.

In an NR-U system, a UE may need to perform Listen Before Talk (LBT) before each UL transmission. LBT failures and unsuccessful transmission (e.g., due to busy channel condition) may affect the transmission of packets using UL resources scheduled by one ore more configured grants. In a case where delay-sensitive data arrives while previously generated packets are still pending, transmission of delay-sensitive data may need to be given priority over retransmission of previously generated packets. Thus, there exists a need for further improvements in the art.

### CITATION LIST

Citation 1: 3GPP TR 38.889 V16.0.0; Study on NR-based access to unlicensed spectrum.

Citation 2: 3GPP TS 37.213 V16.2.0; LTE; 5G; Physical layer procedures for shared spectrum channel access.

Citation 3: TS 38.214 V16.2.0; 5G; NR; Physical layer procedures for data.

Citation 4: TS 38.212 V16.2.0; 5G; NR; Multiplexing and channel coding.

Citation 5: TS 38.331 V16.1.0; 5G; NR; Radio Resource Control (RRC); protocol specification.

Citation 6: TS 38.321 V16.1.0; 5G; NR; Medium Access Control (MAC); protocol specification.

Citation 7: TS 38.211 V16.2.0; 5G; NR; Physical channels and modulation.

Citation 8: RP-201310; Revised WID: Core part: Enhanced Industrial Internet of Things (IoT) and ultra-reliable and low latency communication (URLLC) support for NR.

### SUMMARY

The present disclosure is related to methods and apparatuses for handling uplink (re)transmission in an unlicensed and controlled environment.

According to a first aspect of the present disclosure, a method for wireless communication performed by a UE is provided. The method includes determining whether a logical channel (LCH)-based prioritization indication is configured, and when the LCH-based prioritization indication is configured, selecting a Hybrid Automatic Repeat Request (HARQ) process identifier (ID) of the CG PUSCH based on a priority of the HARQ process ID.

In an implementation of the first aspect, the HARQ process ID is used for initial transmission.

In yet another implementation of the first aspect, the HARQ process ID is used for retransmission.

In yet another implementation of the first aspect, the priority of the HARQ process ID is the highest among priorities of all HARQ process IDs for the CG configuration.

In yet another implementation of the first aspect, the priority of the HARQ process ID is determined by an LCH with the highest LCH priority among one or more LCHs with data that is multiplexed in a Medium Access Control (MAC) protocol data unit (PDU) for retransmission on the CG PUSCH, when the HARQ process ID is used for retransmission.

In yet another implementation of the first aspect, the priority of the HARQ process ID is determined by an LCH with the highest LCH priority among one or more LCHs with data that can be multiplexed in a Medium Access Control (MAC) protocol data unit (PDU) for transmission on the CG PUSCH, when the HARQ process ID is used for initial transmission.

In yet another implementation of the first aspect, the method further comprises selecting a Medium Access Control (MAC) protocol data unit (PDU) associated with the HARQ process ID for transmission on the CG PUSCH.

In yet another implementation of the first aspect, the method further comprises when the LCH-based prioritization indication is not configured, prioritizing a HARQ process ID for retransmission over a HARQ process ID for initial transmission.

In yet another implementation of the first aspect, the transmission on the CG PUSCH is on an unlicensed frequency band.

In yet another implementation of the first aspect, the method further comprises determining whether a configured grant retransmission timer (cg-Retransmission Timer) is configured, where selecting the HARQ process ID of the CG PUSCH based on the priority of the HARQ process ID is performed, when the cg-RetransmissionTimer and the LCH-based prioritization indication are configured.

According to a second aspect of the present disclosure, a user equipment (UE) is provided. The UE includes one or more non-transitory computer-readable media containing computer-executable instructions embodied therein, and at least one processor coupled to the one or more non-transitory computer-readable media. The at least one processor is configured to execute the computer-executable instructions to determine whether a logic channel (LCH)-based prioritization indication is configured, and when the LCH-based prioritization indication is configured, select a Hybrid Automatic Repeat Request (HARQ) process identifier (ID) of the CG PUSCH based on a priority of the HARQ process ID.

In an implementation of the second aspect, the HARQ process ID is used for initial transmission.

In yet another implementation of the second aspect, the HARQ process ID is used for retransmission.

In yet another implementation of the second aspect, the priority of the HARQ process ID is the highest among priorities of all HARQ process IDs for the CG configuration.

In yet another implementation of the second aspect, the priority of the HARQ process ID is determined by an LCH with the highest LCH priority among one or more LCHs with data that is multiplexed in a Medium Access Control (MAC) protocol data unit (PDU) for retransmission on the CG PUSCH, when the HARQ process ID is used for retransmission.

In yet another implementation of the second aspect, the priority of the HARQ process ID is determined by an LCH with the highest LCH priority among one or more LCHs with data that can be multiplexed in a Medium Access Control (MAC) protocol data unit (PDU) for transmission on the CG PUSCH, when the HARQ process ID is used for initial transmission.

In yet another implementation of the second aspect, the at least one processor is further configured to execute the computer-executable instructions to select a Medium Access Control (MAC) protocol data unit (PDU) associated with the HARQ process ID for transmission on the CG PUSCH.

In yet another implementation of the second aspect, the at least one processor is further configured to execute the computer-executable instructions to when the LCH-based prioritization indication is not configured, prioritize a HARQ process ID for retransmission over a HARQ process ID for initial transmission.

In yet another implementation of the second aspect, the transmission on the CG PUSCH is on an unlicensed frequency band.

In yet another implementation of the second aspect, the at least one processor is further configured to execute the computer-executable instructions to determine whether a configured grant retransmission timer (cg-RetransmissionTimer) is configured, where selecting the HARQ process ID of the CG PUSCH based on the priority of the HARQ process ID is performed, when the cg-RetransmissionTimer and the LCH-based prioritization indication are configured.

### BRIEF DESCRIPTION OF THE DRAWINGS

Aspects of the disclosure are best understood from the following detailed description when read with the accompanying drawings. Various features are not drawn to scale. Dimensions of various features may be arbitrarily increased or reduced for clarity of discussion.

FIG. 1 illustrates a diagram of a configured grant timer (configuredGrantTimer) operation in accordance with NR Rel-15.

FIG. 2 illustrates a diagram of CG operations of a cg-RetransmissionTimer in accordance with NR Rel-16 NR-U.

FIG. 3 illustrates a diagram of selecting a HARQ process ID of a CG PUSCH in accordance with a mechanism as described in NR Rel-16 NR-U.

FIG. 4 illustrates a flowchart of a method by a UE for prioritizing HARQ process ID(s) of initial transmission or retransmission when selecting a HARQ process ID of a CG PUSCH in accordance with an example implementation of the present disclosure.

FIG. 5 illustrates a flowchart of a method by a UE for prioritizing HARQ process ID(s) of initial transmission or retransmission when selecting a HARQ process ID of a CG PUSCH in accordance with an example implementation of the present disclosure.

FIG. 6 illustrates a diagram of selecting a HARQ process ID of a CG PUSCH in accordance with an example implementation of the present disclosure.

FIG. 7 illustrates a diagram of handling CG retransmission in accordance with an example implementation of the present disclosure.

FIG. 8 is a block diagram illustrating a node for wireless communication in accordance with various aspects of the present disclosure.

### DESCRIPTION

The acronyms used in the present disclosure are defined as follows. Unless otherwise specified, the acronyms have the following meanings.

| Acronym | Full name |
|---|---|
| 3GPP | 3^{rd} Generation Partnership Project |
| 5G | 5^{th} Generation |
| 5GC | 5^{th} Generation Core |
| ACK | Acknowledgment |
| BFR | Beam Failure Recovery |
| BS | Base Station |
| BSR | Buffer Status Report |
| BWP | Band Width Part |
| CAPC | Channel Access Priority Class |
| CBRA | Contention Based Random Access |
| CC | Component Carrier |
| CCA | Clear Channel Assessment |
| CCCH | Common Control Channel |
| CE | Control Element |
| CG | Cell Group |
| COT | Channel Occupancy Time |
| C-RNTI | Cell Radio Network Temporary Identifier |
| CS-RNTI | Configured Scheduling Radio Network |
| | Temporary Identifier |
| CSI | Channel State information |
| DC | Dual Connectivity |
| DCCH | Dedicated Control Channel |
| DCI | Downlink Control Information |
| DFI | Downlink Feedback Information |
| DL | Downlink |
| E-UTRAN | Evolved Universal Terrestrial Radio Access Network |
| EPC | Evolved Packet Core |
| FBE | Frame based equipment |
| FFP | Fixed Frame Period |
| GC-PDCCH | Group Common Physical Downlink Control Channel |
| HARQ | Hybrid Automatic Repeat Request |
| IE | Information Element |
| IIoT | Industrial Internet of Things |
| LAA | Licensed Assisted Access |
| LBT | Listen Before Talk |
| LCID | Logical Channel Identity |
| LCP | Logical Channel Prioritization |
| LSB | Least Significant Bit |
| LTE | Long Term Evolution |
| L1 | Layer 1 |
| MAC | Medium Access Control |
| MCG | Master Cell Group |
| MCOT | Maximum Channel Occupancy Time |
| MIMO | Multi-input Multi-output |
| MN | Master Node |
| MSB | Most Significant Bit |
| NACK | Negative Acknowledgment |
| NDI | New Data Indicator |
| NR | New RAT/Radio |
| NR-U | New Radio Unlicensed |
| NW | Network |
| PBCH | Physical Broadcast Channel |
| PCell | Primary Cell |
| PDCCH | Physical Downlink Control Channel |
| PDSCH | Physical Downlink Shared Channel |
| PDU | Protocol Data Unit |
| PHY | Physical |
| PHR | Power Head Room |
| PRACH | Physical Random Access Channel |
| PSCell | Primary Secondary Cell |
| PUCCH | Physical Uplink Control Channel |
| PUSCH | Physical Uplink Shared Channel |
| RA | Random Access |
| RAN | Radio Access Network |
| RAR | Random Access Response |
| Rel-15 | Release-15 |
| Rel-16 | Release-16 |
| RLF | Radio Link Failure |
| RMSI | Remaining Minimum System Information |
| RNTI | Radio Network Temporary Identifier |
| RRC | Radio Resource Control |
| RV | Redundancy Version |
| SCell | Secondary Cell |
| SCG | Secondary Cell Group |
| SCS | Subcarrier Spacing |
| SpCell | Special Cell |
| SR | Scheduling Request |
| SRB | Signaling Radio Bearer |
| SRS | Sounding Reference Signal |
| SSB | Synchronization Signal Block |
| TAG | Timing Advance Group |
| TB | Transport Block |
| TBS | Transport Block Size |
| TDD | Time Division Duplex |
| TDRA | Time Domain Resource Allocation |
| TR | Technical Report |
| TS | Technical Specification |
| TX | Transmission |
| UE | User Equipment |
| UCI | Uplink Control Information |
| UL | Uplink |
| URLLC | Ultra Reliable Low Latency Communication |
| WG | Working Group |
| WI | Working Item |

The following description contains specific information related to implementations of the present disclosure. The drawings and their accompanying detailed description are merely directed to implementations. However, the present disclosure is not limited to these implementations. Other variations and implementations of the present disclosure will be obvious to those skilled in the art.

Unless noted otherwise, like or corresponding elements among the drawings may be indicated by like or corresponding reference numerals. Moreover, the drawings and illustrations in the present disclosure are generally not to scale and are not intended to correspond to actual relative dimensions.

For the purpose of consistency and ease of understanding, like features may be identified (although, in some examples, not illustrated) by the same numerals in the drawings. However, the features in different implementations may be differed in other respects and shall not be narrowly confined to what is illustrated in the drawings.

The phrases “in one implementation,” or “in some implementations,” may each refer to one or more of the same or different implementations. The term “coupled” is defined as connected whether directly or indirectly through intervening components and is not necessarily limited to physical connections. The term “comprising” means “including, but not necessarily limited to” and specifically indicates open-ended inclusion or membership in the so-described combination, group, series or equivalent. The expression “at least one of A, B and C” or “at least one of the following: A, B and C” means “only A, or only B, or only C, or any combination of A, B and C.”

The terms “system” and “network” may be used interchangeably. The term “and/or” is only an association relationship for describing associated objects and represents that three relationships may exist such that A and/or B may indicate that A exists alone, A and B exist at the same time, or B exists alone. The character “/” generally represents that the associated objects are in an “or” relationship.

For the purposes of explanation and non-limitation, specific details such as functional entities, techniques, protocols, and standards are set forth for providing an understanding of the disclosed technology. In other examples, detailed description of well-known methods, technologies, systems, and architectures are omitted so as not to obscure the description with unnecessary details.

Persons skilled in the art will immediately recognize that any network function(s) or algorithm(s) disclosed may be implemented by hardware, software or a combination of software and hardware. Disclosed functions may correspond to modules which may be software, hardware, firmware, or any combination thereof.

A software implementation may include computer-executable instructions stored on a computer-readable medium such as memory or other types of storage devices. One or more microprocessors or general-purpose computers with communication processing capability may be programmed with corresponding executable instructions and perform the disclosed network function(s) or algorithm(s).

The microprocessors or general-purpose computers may include Applications Specific Integrated Circuitry (ASIC), programmable logic arrays, and/or using one or more Digital Signal Processor (DSPs). Although some of the disclosed implementations are oriented to software installed and executing on computer hardware, alternative implementations implemented as firmware or as hardware or as a combination of hardware and software are well within the scope of the present disclosure. The computer readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture such as a Long Term Evolution (LTE) system, an LTE-Advanced (LTE-A) system, an LTE-Advanced Pro system, or a 5G NR Radio Access Network (RAN) typically includes at least one base station (BS), at least one UE, and one or more optional network elements that provide connection within a network. The UE communicates with the network such as a Core Network (CN), an Evolved Packet Core (EPC) network, an Evolved Universal Terrestrial RAN (E-UTRAN), a 5G Core (5GC), or an internet via a RAN established by one or more BSs.

A UE may include but is not limited to a mobile station, a mobile terminal or device, or a user communication radio terminal. The UE may be a portable radio equipment that includes but is not limited to a mobile phone, a tablet, a wearable device, a sensor, a vehicle, or a Personal Digital Assistant (PDA) with wireless communication capability. The UE is configured to receive and transmit signals over an air interface to one or more cells in a RAN.

The BS may be configured to provide communication services according to at least a Radio Access Technology (RAT) such as Worldwide Interoperability for Microwave Access (WiMAX), Global System for Mobile communications (GSM) that is often referred to as 2G, GSM Enhanced Data rates for GSM Evolution (EDGE) RAN (GERAN), General Packet Radio Service (GPRS), Universal Mobile Telecommunication System (UMTS) that is often referred to as 3G based on basic wideband-code division multiple access (W-CDMA), high-speed packet access (HSPA), LTE, LTE-A, evolved LTE (eLTE) that is LTE connected to 5GC, NR (often referred to as 5G), and/or LTE-A Pro. However, the scope of the present disclosure is not limited to these protocols.

The BS may include but is not limited to a node B (NB) in the UMTS, an evolved node B (eNB) in LTE or LTE-A, a radio network controller (RNC) in UMTS, a BS controller (BSC) in the GSM/GERAN, an ng-eNB in an Evolved Universal Terrestrial Radio Access (E-UTRA) BS in connection with 5GC, a next generation Node B (gNB) in the 5G-RAN, or any other apparatus capable of controlling radio communication and managing radio resources within a cell. The BS may serve one or more UEs via a radio interface.

The BS is operable to provide radio coverage to a specific geographical area using a plurality of cells forming the RAN. The BS supports the operations of the cells. Each cell is operable to provide services to at least one UE within its radio coverage.

Each cell (often referred to as a serving cell) provides services to serve one or more UEs within its radio coverage such that each cell schedules the DL and optionally uplink (UL) resources to at least one UE within its radio coverage for DL and optionally UL packet transmissions. The BS can communicate with one or more UEs in the radio communication system via the plurality of cells.

A cell may allocate SL resources for supporting Proximity Service (ProSe) or Vehicle to Everything (V2X) service. Each cell may have overlapped coverage areas with other cells.

As discussed previously, the frame structure for NR supports flexible configurations for accommodating various next generation (e.g., 5G) communication requirements such as Enhanced Mobile Broadband (eMBB), Massive Machine Type Communication (mMTC), and Ultra-Reliable and Low-Latency Communication (URLLC), while fulfilling high reliability, high data rate and low latency requirements. The Orthogonal Frequency-Division Multiplexing (OFDM) technology in the 3rd Generation Partnership Project (3GPP) may serve as a baseline for an NR waveform. The scalable OFDM numerology such as adaptive sub-carrier spacing, channel bandwidth, and Cyclic Prefix (CP) may also be used.

Two coding schemes are considered for NR, specifically Low-Density Parity-Check (LDPC) code and Polar Code. The coding scheme adaption may be configured based on channel conditions and/or service applications.

When a transmission time interval (TTI) of a single NR frame includes DL transmission data, a guard period, and UL transmission data, the respective portions of the DL transmission data, the guard period, and the UL transmission data may be configured based on the network dynamics of NR. SL resources may also be provided in an NR frame to support ProSe services or V2X services.

Example description of some selected terms used in this disclosure are given below.

Primary Cell (PCell): For dual connectivity (DC) operation, PCell is the master cell group (MCG) cell, operating on the primary frequency, in which the UE either performs the initial connection establishment procedure or initiates the connection re-establishment procedure.

Primary SCG Cell (PSCell): For DC operation, PSCell is the secondary cell group (SCG) cell in which the UE performs random access when performing the Reconfiguration with Sync procedure.

Special Cell: For DC operation the term Special Cell (SpCell) refers to the PCell of the MCG or the PSCell of the SCG, otherwise the term Special Cell refers to the PCell.

Secondary Cell: For a UE configured with carrier aggregation (CA), a cell providing additional radio resources on top of Special Cell.

Serving Cell: For a UE in RRC_CONNECTED not configured with CA/DC, there is only one serving cell, which may be referred to as the primary cell. For a UE in RRC_CONNECTED configured with CA/DC, the term “serving cells” may be used to denote the set of cells including the SpCell(s) and all secondary cells.

Listen Before Talk (LBT) is a feature available in Wi-Fi that allows coexistence with other Wi-Fi nodes. LBT is a mechanism by which an equipment applies clear channel assessment (CCA) before using the channel. The 3rd Generation Partnership Project (3GPP) chose to specify a conservative LBT scheme similar to what Wi-Fi nodes use in order to ensure coexistence of Licensed Assisted Access (LAA) with Wi-Fi. LAA uses carrier aggregation in DL to combine LTE in the unlicensed spectrum (e.g., 5 GHz) with LTE in the licensed band. In NR, LBT may be also required prior to any transmission when operating on the unlicensed spectrum.

In an unlicensed spectrum, a UE may perform channel access before performing a transmission in order to make sure that there is no other device occupying the channel where the transmission is intended to be performed. For channel access mechanism in NR-U operations, the LTE-LAA LBT mechanism may be adopted as the baseline for 5 GHz band and as the starting point of the design for 6 GHz band. At least for bands where absence of Wi-Fi cannot be guaranteed (e.g., by regulation), LBT may be performed in units of 20 MHz. In general, there are 4 LBT categories. The introduction of each LBT category may be found below. For NR-U operations, a UE may perform LBT using one of the 4 LBT categories before performing an UL transmission for different transmissions in a COT (as defined below) and different channels/signals to be transmitted. Specifically, a UE may perform LBT using different LBT categories before performing PRACH, PUCCH, PUSCH and SRS transmissions.

Category 1: Immediate Transmission after a Short Switching Gap

This may be used for a transmitter to immediately transmit after a switching gap inside a COT. More specifically, the switching gap from reception to transmission is to accommodate the transceiver turnaround time and is no longer than 16 μs. It is noted that a Category 1 transmission may also be referred to as a Type 2 (UL) channel access procedure.

Category 2: LBT without Random Back-Off

The duration of time that the channel (where transmission is intended to be performed) is sensed to be idle before the transmitting entity transmits is deterministic. It is noted that a Category 2 transmission may also be referred to as a Type 2 (UL) channel access procedure.

Category 3: LBT with Random Back-Off with a Contention Window of Fixed Size

The LBT procedure has the following procedure as one of its components. The transmitting entity draws a random number N within a contention window. The size of the contention window is specified by a “minimum possible value of N” and a “maximum possible value of N”. The size of the contention window is fixed. The random number N is used in the LBT procedure to determine the duration of time that the channel (where transmission is intended to be performed) is sensed to be idle before the transmitting entity transmits on the channel. In one example, the “minimum possible value of N” and the “maximum possible value of N” may be determined by a channel access priority class of a UE. Moreover, the channel access priority class may be determined based on the type of UL transmission that the UE intends to perform.

Category 4: LBT with Random Back-Off with a Contention Window of Variable Size

The LBT procedure has the following as one of its components. The transmitting entity draws a random number N within a contention window. The size of contention window is specified by a “minimum possible value of N” and a “maximum possible value of N”. The transmitting entity can vary the size of the contention window when drawing the random number N. The random number N is used in the LBT procedure to determine the duration of time that the channel (where transmission is intended to be performed) is sensed to be idle before the transmitting entity transmits on the channel. It is noted that a Category 4 transmission may also be referred to as a Type 1 (UL) channel access procedure. In one example, the “minimum possible value of N” and the “maximum possible value of N” may be determined by a channel access priority class of a UE. Moreover, the channel access priority class may be determined based on the type of UL transmission that the UE intends to perform.

The transmission may be performed by a UE only if the LBT is successful, for example, as explained in each of the LBT categories discussed above. Moreover, the maximum continuous transmission time (upon successful LBT) may be predetermined by a COT value.

LBT may be considered successful if the channel is sensed to be idle (e.g., the power detected by a UE, which intends to perform a UL transmission, is less than a predetermined/configured power threshold) for a predetermined/configured duration of time during an LBT procedure, if LBT category 2/3/4 is performed. LBT may be considered successful if the UE performs LBT category 1. Otherwise, an LBT failure may be considered. The MAC entity of the UE may receive an LBT failure indication from the PHY layer of the UE upon one or multiple LBT failures.

In various implementations of the present disclosure, the term “UL LBT” may be referred to an LBT procedure performed by the UE before an UL transmission. The term “DL LBT” may be referred to an LBT procedure performed by the network before an DL transmission.

Frame Based Equipment (FBE)

An FBE is an equipment that may operate in an unlicensed environment. The transmit/receive structure of an FBE has a periodic timing with a periodicity equal to a fixed frame period (FFP). Two types of devices are defined for FBE operations, where a device that initiates a sequence of one or more transmissions is defined as an initiating device. Otherwise, the device is defined as a responding device.

To initiate a sequence of one or more transmissions, an initiating device may perform a clear channel assessment (CCA) check during a single observation slot/idle period immediately before starting transmissions on an operating channel at the start of a FFP. If the operating channel is found to be clear, the initiating device may start the transmission immediately in the FFP. Otherwise, there may not be transmissions on that channel during the next FFP. It is noted that the observation slot/idle period for the CCA and duration for the transmission may be in the same FFP.

An initiating device is allowed to grant an authorization to one or more associated responding devices to transmit on the current operating channel within the current COT. A responding device may proceed transmissions without performing a CCA if it receives a grant and if these transmissions are initiated at most 16 μs after the last transmission by the initiating device that issued the grant. In another example, a responding device may perform a CCA, which starts from 16 μs after the last transmission performed by the initiating device that issued the grant and ends immediately before the granted transmission time. Moreover, the CCA may be 25 μs long.

A responding device may perform a CCA on the operating channel during a single observation slot within a 25 μs period ending immediately before the granted transmission time which are later than 16 μs after the last transmission by the initiating device that issued the grant.

In NR Rel-16 NR-U, a gNB may operate as an initiating device. For example, a gNB provides the FFP configuration to a UE via SIB1 or dedicated RRC signaling (e.g., the UE is configured, by the network, channelAccessMode=SemiStaticChannelAccessConfig via SIB1 or dedicated RRC signaling). The FFP (e.g., defined by the period IE in the SemiStaticChannelAccessConfig IE) is restricted to values of {1 ms, 2 ms, 2.5 ms, 4 ms, 5 ms, 10 ms}. The starting positions of the FFPs within every two radio frames starts from an even radio frame and are given by i*P where i={0, 1, . . . , 20/P−1} where P is the fixed frame period in milliseconds. The observation slot/idle period for a given SCS=ceil (minimum observation slot/idle period allowed by regulations/Ts), where minimum observation slot/idle period allowed=max (5% of FFP, 100 μs), and Ts is the symbol duration for the given SCS. UE transmissions within a fixed frame period can occur if DL signals/channels (e.g., PDCCH, SSB, PBCH, RMSI, GC-PDCCH, etc.) within the fixed frame period are detected. A PRACH resource is considered invalid if it overlaps with the observation slot/idle period of an FFP when FBE operation is indicated.

Configured Uplink Grant

With configured uplink grants, the network can allocate UL resources (e.g., PUSCH resources) for initial HARQ transmissions to UEs via RRC configurations (and PDCCHs). Two types of configured uplink grants are defined. With a configured uplink grant Type 1, RRC directly provides the configured uplink grant (including the periodicity). The UL resource (e.g., PUSCH resource) that corresponds to a configured grant Type 1 configuration is configured directly by the network via RRC signaling. With configured uplink grant Type 2, RRC defines the periodicity of the configured uplink grant while PDCCH addressed to CS-RNTI can either signal and activate the configured uplink grant, or deactivate it. For example, a PDCCH addressed to CS-RNTI indicates that the uplink grant can be implicitly reused according to the periodicity defined by RRC, until deactivated. In other words, the uplink resource scheduled by the uplink grant, as indicated by the PDCCH addressed to CS-RNTI, may occur periodically according to the periodicity defined by RRC, until deactivated.

The types (e.g., Type 1 and Type 2) of configured uplink grants may be configured by RRC per serving cell and per BWP. Multiple configurations can be active simultaneously on different serving cells. For a configured grant Type 2, activation and deactivation are independent among the serving cells. For the same serving cell, the MAC entity is configured with either Type 1 or Type 2.

RRC configures the following parameters when the configured grant Type 1 is configured:
cs-RNTI: CS-RNTI for retransmission;
periodicity: periodicity of the configured grant Type 1;
timeDomainOffset: Offset of a resource with respect to SFN=0 in time domain;
timeDomainAllocation: Allocation of configured uplink grant in time domain which contains startSymbolAndLength (e.g., SLIV in Citation 3);
nrofHARQ-Processes: the number of HARQ processes for configured grant.

Upon configuration of a configured grant Type 1 for a serving cell by upper layers, the MAC entity may (1) store the uplink grant provided by upper layers as a configured uplink grant for the indicated serving cell; (2) initialize or re-initialize the configured uplink grant to start in the symbol according to timeDomainOffset and S (derived from SLIV as specified in Citation 3), and to reoccur with periodicity.

In NR Rel-15, a configuredGrantTimer is introduced. This timer is maintained per HARQ process ID. For example, when a UE performs a specific (re-)transmission (e.g., on a resource indicated by an uplink grant addressed to C-RNTI and the identified HARQ process is configured for a configured uplink grant, on a PUSCH that corresponds to a configured uplink grant (e.g., CG PUSCH), or on a resource indicated by an uplink grant addressed to CS-RNTI), a configuredGrantTimer that corresponds to the HARQ process ID of the (re-)transmission is (re)started. While a configuredGrantTimer that corresponds to a HARQ process is running, the UE is prohibited from performing a new transmission (e.g., generate a new MAC PDU for transmission) on a configured uplink grant of the HARQ process ID.

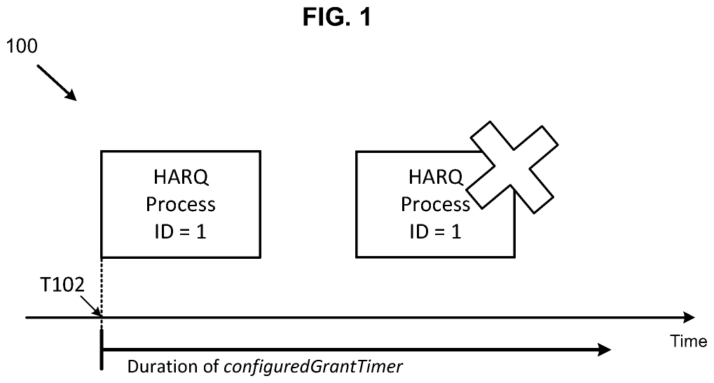

FIG. 1 illustrates a diagram of a configured grant timer (configuredGrantTimer) operation in accordance with NR Rel-15. As illustrated in diagram 100, a configured grant timer (configuredGrantTimer) starts running at time T102. While the configuredGrantTimer is running, the latest CG PUSCH cannot be used for new transmissions.

Configured Uplink Grant Features in NR Rel-16 NR-U

Several new features related to configured uplink grant (e.g., features 1-1 to 1-5 as listed below) are introduced in NR Rel-16 NR-U WI to ensure configured uplink grant mechanisms/operations can operate smoothly in an unlicensed environment (e.g., shared spectrum) where LBT failures may occur. In one implementation, a configured grant configuration may apply at least one of the features listed below only if a configured grant retransmission timer (cg-RetransmissionTimer) is configured in the configured grant configuration information element (e.g., ConfiguredGrantConfig IE). In addition, a cg-RetransmissionTimer may always be configured in a configured grant configuration information element (e.g., ConfiguredGrantConfig IE) that operates in an unlicensed environment (e.g., a shared spectrum). Moreover, the cg-RetransmissionTimer may not be configured in a configured grant configuration (e.g., ConfiguredGrantConfig IE) that operates in a licensed environment (e.g., a licensed spectrum).

Feature 1-1: HARQ Process ID Selection of a CG PUSCH based on UE Implementation

The selection of HARQ process ID for a CG PUSCH may be based on UE implementation. A UE may select a HARQ process ID for a CG PUSCH among the HARQ process IDs available for the configured grant configuration. More specifically, the HARQ process IDs available for the configured grant configuration may be determined based on the value of two parameters, harq-procID-Offset and nrofHARQ-Processes, as configured in the configured grant configuration (e.g., ConfiguredGrantConfig IE).

In one implementation, if both harq-procID-Offset and nrofHARQ-Processes are configured in a configured grant configuration (e.g., ConfiguredGrantConfig IE), a UE may select a HARQ process ID for a CG PUSCH within [harq-procID-Offset, . . . , (harq-procID-Offset+nrofHARQ-Processes−1)].

In one implementation, if only nrofHARQ-Processes is configured in a configured grant configuration (e.g., ConfiguredGrantConfig IE), a UE may select a HARQ process ID for a CG PUSCH within [0, 1, . . . , (nrofHARQ-Processes−1)].

In one implementation, harq-procID-Offset may always be configured together with cg-RetransmissionTimer in a configured grant configuration (e.g., ConfiguredGrantConfig IE) that operates in an unlicensed environment (e.g., a shared spectrum).

In one implementation, a UE may prioritize retransmissions before initial transmissions when selecting a HARQ process ID for a CG PUSCH.

In one implementation, when selecting a HARQ process ID of a CG PUSCH via UE implementation, a CG-UCI may be used to indicate the HARQ process ID that is selected for the CG PUSCH. In some aspect of the present implementation, the CG-UCI may be multiplexed on the CG PUSCH.

In one implementation, a CG-UCI may include HARQ process ID, RV, NDI, and COT information of a CG PUSCH (that the CG-UCI multiplexes with).

In one implementation, the UE may toggle the NDI in the CG-UCI for new transmissions and may not toggle the NDI in the CG-UCI in retransmissions.

Feature 1-2: RV Selection of a CG PUSCH Based on UE Implementation

In one implementation, a UE may select a RV of a CG PUSCH based on UE implementation. Moreover, the CG PUSCH may be for initial transmission or for retransmission (e.g., repetition).

Feature 1-3: Autonomous Retransmission of a MAC PDU on a CG PUSCH

When a UE fails to transmit a generated MAC PDU on a first CG PUSCH, the UE may perform autonomous retransmission on a second CG PUSCH if at least one of the following conditions are satisfied. For example, the UE may fail to transmit a MAC PDU due to LBT failure (e.g., the UE senses the channel to be busy, the UE receives a LBT failure indication, etc.). The UE may consider the NDI bit to not have been toggled when it determines to perform autonomous retransmission on a second CG PUSCH.

The conditions may include, and are not limited to, the following:
The TBS of the first CG PUSCH and the second CG PUSCH are the same.
The first CG PUSCH and the second CG PUSCH has the same HARQ process ID.
The configured grant configuration(s) that the first CG PUSCH and the second CG PUSCH correspond to are configured in the same BWP.
In one example, the configured grant configuration(s) that corresponds to the first CG PUSCH and the second CG PUSCH may or may not be the same. However, they need to be configured in the same BWP.
The network has not provided a dynamic grant for retransmission of the first CG PUSCH.
In one example, the dynamic grant for retransmission of the first CG PUSCH may have the same HARQ process ID as the first CG PUSCH.
In one example, if the network has provided a dynamic grant (e.g., an UL grant associated with C-RNTI or CS-RNTI) for retransmission of the first CG PUSCH before the second CG PUSCH becomes available, the second CG PUSCH may not be used for autonomous retransmission.
The cg-RetransmissionTimer that correspond to the HARQ process ID of the first (and second) PUSCH is not running.
In one example, the cg-RetransmissionTimer may be configured per HARQ process ID. It may be used to prohibit a UE to perform immediate autonomous retransmission on a CG PUSCH. The UE may only perform retransmission on a CG PUSCH if the cg-RetransmissionTimer for the HARQ process of the CG PUSCH is not running.
In one example, the cg-RetransmissionTimer of a HARQ process may be (re)started when transmission (e.g., new transmission or retransmission) on a configured uplink grant of the HARQ process is performed successfully (e.g., the UE does not receive a LBT failure indication for the corresponding transmission).
In one example, the cg-RetransmissionTimer of a HARQ process may be stopped when the UE receives a DFI for the corresponding HARQ process.
In one example, the cg-RetransmissionTimer of a HARQ process may be stopped when the UE receives a dynamic grant (e.g., an UL grant associated with C-RNTI or CS-RNTI) for the HARQ process.
In one example, the cg-RetransmissionTimer of a HARQ process may be stopped when the configuredGrantTimer for the HARQ process expires.
In one example, the cg-RetransmissionTimer of a HARQ process may be stopped when a configured grant Type 2 activation command is received for a configured grant configuration that the HARQ process corresponds to.

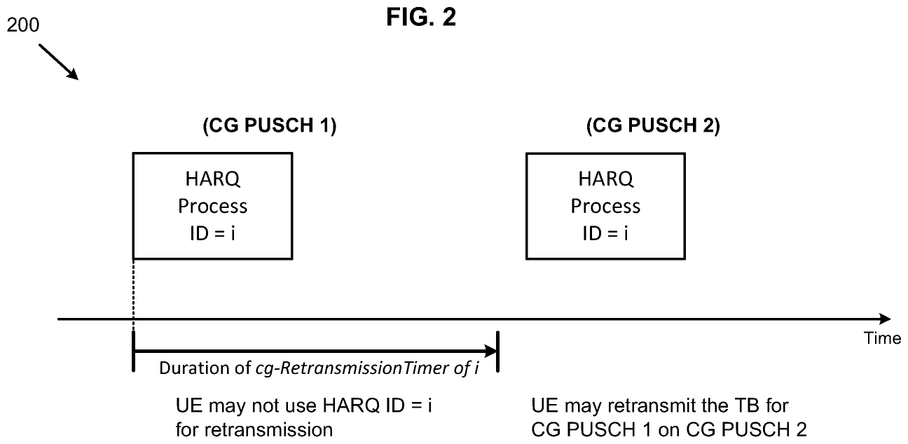

FIG. 2 illustrates a diagram of CG operations of a cg-RetransmissionTimer in accordance with NR Rel-16 NR-U. In diagram 200, during the operations of the cg-RetransmissionTimer, HARQ process ID=i. During the cg-RetransmissionTimer of i, a UE may not use HARQ process ID=i for retransmission. After the cg-RetransmissionTimer of i expires, the UE may retransmit a TB for CG PUSCH 1 on CG PUSCH 2 with HARQ process ID=i.

Feature 1-4: DFI Transmission from the Network

In one implementation, a UE may be expected to receive DFI from the network. DFI may be indicated via a format 0_1 DCI with CRC scrambled by CS-RNTI [4]). When a UE receives a format 0_1 DCI with CRC scrambled by CS-RNTI, the UE may identify that the received DCI is a DFI if the (1-bit) DFI flag in the DCI indicates a value of 1. Moreover, the DFI flag in a format 0_1 DCI may be either 0-bit or 1-bit. The DFI flag is 1 bit if the UE is configured to monitor DCI format 0_1 with CRC scrambled by CS-RNTI and for operation in a cell with shared spectrum channel access.

In one implementation, a DFI may include a (16-bit) HARQ-ACK bitmap, where the order of the bitmap to HARQ process index mapping is such that HARQ process indices are mapped in ascending order from MSB to LSB of the bitmap. For each bit of the bitmap, value 1 indicates ACK, and value 0 indicates NACK as described in Citation 4.

In one implementation, a cg-minDFI-Delay IE as described in Citation 5 may be configured in a configured grant configuration (e.g., ConfiguredGrantConfig IE). When configured in a configured grant configuration (e.g., ConfiguredGrantConfig IE), the cg-minDFI-Delay IE may indicate the minimum duration (in unit of symbols) from the ending symbol of a CG PUSCH to the starting symbol of the PDCCH containing the DFI carrying HARQ-ACK for this CG PUSCH. The HARQ-ACK received before the minimum duration (e.g., received before a period defined by the minimum duration) may not be considered as valid for this CG PUSCH.

In one implementation, the cg-RetransmissionTimer of a HARQ process may be stopped when the UE receives a (valid) DFI for the corresponding HARQ process.

In one implementation, the configuredGrantTimer of a HARQ process may be stopped when the UE receives a (valid) DFI indicating ACK for the corresponding HARQ process.

Feature 1-5: UE Behavior Upon LBT Failure

In one implementation, if a CG PUSCH is not successfully transmitted due to LBT failure, the configuredGrantTimer that corresponds to the HARQ process ID of the CG PUSCH is not (re)started. In one implementation, a configuredGrantTimer that corresponds to a HARQ process ID is only (re)started if LBT failure indication is not received from PHY when transmission is performed (e.g., successful transmission) for the HARQ process.

In one implementation, if a CG PUSCH is not successfully transmitted due to LBT failure, the cg-RetransmissionTimer that corresponds to the HARQ process of the CG PUSCH is not (re)started. In one implementation, a cg-RetransmissionTimer that corresponds to a HARQ process ID is only (re)started if LBT failure indication is not received from PHY when transmission is performed (e.g., successful transmission) for the HARQ process.

Configured Uplink Grant Features in NR Rel-16 IIoT/URLLC

A device that supports NR Rel-16 IIoT/URLLC features may be operated under a licensed spectrum (e.g., a licensed carrier/cell). Several new features related to configured uplink grant (e.g., features 2-1 to 2-4 below) are introduced in NR Rel-16 IIoT/URLLC WI to ensure configured uplink grants mechanism can meet the reliability and delay requirement of IIoT/URLLC traffic. In one implementation, a configured grant configuration may apply at least one of the features listed below only if cg-Retransmission Timer is not configured in the configured grant configuration (e.g., ConfiguredGrantConfig IE). Moreover, cg-RetransmissionTimer may not be configured in a configured grant configuration (e.g., ConfiguredGrantConfig IE) that operates in a licensed environment (e.g., licensed spectrum).

Feature 2-1: HARQ Process ID Selection of a CG PUSCH Based on a Predefined Equation

In one implementation, for a configured grant configuration that is neither configured with harq-ProcID-Offset2 nor with cg-RetransmissionTimer (e.g., Neither harq-ProcID-Offset2 nor with cg-Retransmission Timer is configured in ConfiguredGrantConfig IE of the configured grant configuration), the HARQ Process ID associated with the first symbol of a CG PUSCH may be derived from predefined equation 1 (as described in Citation 6):

HARQ Process ID=[floor(CURRENT_symbol/periodicity)]modulo nrofHARQ-Processes (Predefined Equation 1)

In one implementation, for a configured grant configuration that is configured with harq-ProcID-Offset2 (e.g., harq-ProcID-Offset2 is configured in ConfiguredGrantConfig IE of the configured grant configuration), the HARQ Process ID associated with the first symbol of a CG PUSCH may be derived from predefined equation 2 (as described in Citation 6):

HARQ Process ID=[floor(CURRENT_symbol/periodicity)]modulo nrofHARQ-Processes+harq-ProcID-Offset2 (Predefined Equation 2)

In one implementation, CURRENT_symbol=(SFN×numberOfSlotsPerFrame×numberOfSymbolsPerSlot+slot number in the frame×numberOfSymbolsPerSlot+symbol number in the slot), and numberOfSlotsPerFrame and numberOfSymbolsPerSlot refer to the number of consecutive slots per frame and the number of consecutive symbols per slot, respectively as specified in Citation 7.

In one implementation, if cg-Retransmission Timer is not configured, a HARQ process is not shared between different configured grant configurations in the same BWP.

In one implementation, harq-ProcID-Offset2 cannot be configured simultaneously with cg-RetransmissionTimer in the same configured grant configuration (e.g., ConfiguredGrantConfig IE).

Feature 2-2: RV Selection of a CG PUSCH Based on Configuration

In one implementation, the RV of a CG PUSCH may be selected based on repk-RV configured in the configured grant configuration (e.g., configuredGrantConfig IE) that the CG-PUSCH corresponds to.

In one implementation, repK-RV defines the redundancy version pattern to be applied to the repetitions.

If the parameter neither repK-RV nor cg-RetransmissionTimer is provided in a configured grant configuration (e.g., configuredGrantConfig IE), the RV for CG PUSCH corresponding to the configured grant configuration may be set to 0.

In one implementation, the parameter repK-RV and cg-RetransmissionTimer cannot be configured in the same configured grant configuration (e.g., configuredGrantConfig IE).

Feature 2-3: Autonomous Transmission of a MAC PDU on a CG PUSCH

When a UE fails to transmit a generated MAC PDU on a first CG PUSCH, the UE may perform autonomous transmission on a second CG PUSCH if (at least one of) the following conditions are satisfied. For example, the UE may fail to transmit a MAC PDU due to the first PUSCH being deprioritized, as a result of intra-UE prioritization.

The conditions may include, and are not limited to, the following:
The TBS of the first CG PUSCH and the second CG PUSCH are the same.
The first CG PUSCH and the second CG PUSCH correspond to the same configured grant configuration in the same BWP.
The first CG PUSCH and the second CG PUSCH has the same HARQ process ID.
In one example, the second CG PUSCH, which has the same HARQ process ID as the first CG PUSCH, may be the CG PUSCH that becomes available first (e.g., that a UE receives first) after the first CG PUSCH.
The network has not provided a dynamic grant for retransmission of the first CG PUSCH.
In one example, the dynamic grant for retransmission of the first CG PUSCH may have the same HARQ process ID as the first CG PUSCH.
In one example, if the network has provided a dynamic grant (e.g., an UL grant associated with C-RNTI or CS-RNTI) for retransmission of the first CG PUSCH before the second CG PUSCH becomes available, the second CG PUSCH may not be used for autonomous retransmission.
The autonomousTx has been configured in the configured grant configuration (e.g., configuredGrantConfig IE) that the second CG PUSCH (and the first CG PUSCH) corresponds to.
In one example, the UE may only perform autonomous transmission on a CG PUSCH only if autonomousTx is configured for the configured grant configuration that the CG PUSCH corresponds to.

Feature 2-4: UE Behavior when a MAC PDU is Deprioritized

In one implementation, if a CG PUSCH is not successfully transmitted due the CG PUSCH being deprioritized, the configuredGrantTimer that corresponds to the HARQ process ID of the CG PUSCH is not (re)started.

As described in Citation 8, one of the core objectives of NR Rel-17 WI on enhanced Industrial Internet of Things (IoT) and URLLC support is to ensure Rel-16 feature compatibility with unlicensed band URLLC/IIoT operation in controlled environment. Particularly, UL enhancements for IIoT/URLLC in unlicensed controlled environments may be studied. This may include harmonizing UL configured grant enhancements in NR-U and IIoT/URLLC introduced in Rel-16 to be applicable for an unlicensed spectrum.

It is noted that, in various implementations of the present disclosure, an unlicensed controlled environment may be referred to as an unlicensed environment with controlled deployment. Thus, interference from other systems using different radio access technology may not be expected or may only sporadically happen. An example of an unlicensed controlled environment may be a factory with equipment (e.g., robots, actuators, sensors, etc.) that operates in one or more unlicensed bands/carriers. Moreover, the equipment may be deployed in a specific manner such that they do not cause interference to one another. However, even with proper deployment, channel access (e.g., LBT/CCA) may still be required by an equipment (e.g., UE, gNB, etc.) before performing a transmission. This implies that LBT failure may still occur in an unlicensed controlled environment.

In contrast to the configured grant mechanisms/schemes introduced in NR Rel-16 NR-U WI that are designed specifically for an unlicensed environment where LBT failures may occur frequently, the configured grant mechanisms/schemes introduced in NR Rel-16 IIoT/URLLC WI aim to meet the service requirements (e.g., delay requirement, reliability requirement, etc.) of IIoT/URLLC data traffic in a licensed environment. Furthermore, based on the defined configuration restriction, these two types of mechanisms/schemes may not be configured simultaneously.

Based on the objective of NR Rel-17 WI on enhanced Industrial Internet of Things (eIIoT) and URLLC support, new mechanisms may be desirable to harmonize configured uplink grant mechanism/schemes in introduced in Rel-16 NR-U WI and Rel-16 IIoT/URLLC WI. Implementations of the present disclosure provide new mechanisms to ensure that IIoT/URLLC service requirement can be met in an unlicensed controlled environment where LBT failures may occur.

Selection of HARQ Process ID of a CG Pusch in an Unlicensed Controlled Environment

According to NR Rel-16 NR-U, the selection of a HARQ process ID of a CG PUSCH may be up to UE implementation. For example, a UE may select a HARQ process ID of the CG PUSCH among the HARQ process ID(s) available for the configured grant configuration that the CG PUSCH corresponds or belongs to. Moreover, a UE may prioritize HARQ process ID(s) for retransmissions before HARQ process ID(s) for initial transmissions when selecting a HARQ process ID. As such, the IIoT/URLLC service requirement in an unlicensed controlled environment cannot not be fulfilled by this mechanism. For instance, a delay-sensitive IIoT/URLLC traffic for initial transmission can be delayed by a delay-tolerant retransmission.

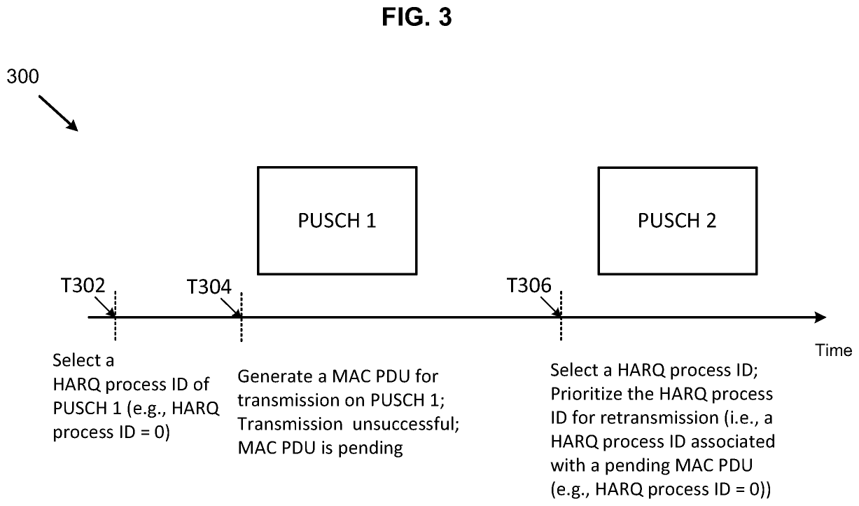

FIG. 3 illustrates a diagram of selecting a HARQ process ID of a CG PUSCH in accordance with a mechanism described in NR Rel-16 NR-U. In FIG. 3, PUSCH 1 and PUSCH 2 belong to the same CG configuration. It is up to UE implementation to select a HARQ process ID for PUSCH 1.

As illustrated in diagram 300, at time T302, a UE selects a HARQ process ID for initial transmission (e.g., HARQ process ID=0). The UE may select the HARQ process ID from a CG configuration HARQ pool (e.g., HARQ process IDs 0, 1, 2, 3) that is configured for the current CG configuration.

At time T304, the UE generates a MAC PDU for transmission on PUSCH 1 when CG PUSCH 1 is available. However, the transmission of the MAC PDU on PUSCH 1 may not be successful, for example, due to either LBT failure or PUSCH 1 being deprioritized as a result of intra-UE prioritization. As a result, the MAC PDU is pending with the HARQ process ID associated with the MAC PDU being 0.

Hence, at time T306, upon CG PUSCH 2 (on the same BWP as CG PUSCH 1) is available, the UE may select a HARQ process ID for retransmission or autonomous transmission for CG PUSCH 2 (e.g., HARQ process ID of 0). As such, the MAC PDU may be (re)transmitted on CG PUSCH 2. It is noted that, it is assumed that CG PUSCH 2 is valid for (re)transmitting the MAC PDU. However, according to the mechanism introduced in Rel-16 NR-U where IIoT data is not involved, the UE would always select the HARQ process ID associated with a pending MAC PDU for retransmission. For example, at time T306, when the UE selects a HARQ process ID, the UE needs to prioritize a HARQ process ID for retransmission over a HARQ process ID for initial transmission. For example, as illustrated in FIG. 3, at time T306, the UE needs to prioritize HARQ process ID 0 associated with the pending MAC PDU for retransmission. The HARQ process ID(s) for new transmission may refer to HARQ process IDs that have not been occupied (e.g., HARQ process IDs 1, 2, and 3). In Rel-16 NR-U where IIoT data is not considered, the UE always prioritizes the HARQ process ID(s) of retransmission over the HARQ process ID(s) of initial transmission to allow transmission of previously pending MAC PDUs which have not been transmitted on a new or next available PUSCH resource. In this mechanism, the UE selects the HARQ process ID of 0 associated with the pending MAC PDU for retransmission of the pending MAC PDU. However, in this mechanism, any (incoming) delay-sensitive IIoT/URLLC traffic (after time T304 and/or before time T306) is not considered, and cannot be transmitted on CG PUSCH 2 even if the pending MAC PDU does not include delay-sensitive data.

In light of the above, implementations of the present disclosure enable a UE to consider both the content of the pending MAC PDU and the presence of incoming data when selecting a HARQ process ID.

It is noted that in various implementations of the present disclosure, a HARQ process ID of initial transmission may not be occupied by an unacknowledged (and pending) MAC PDU, while a HARQ process ID of retransmission may be occupied by an unacknowledged (and pending) MAC PDU. It is also noted that in various implementations of the present disclosure, an unacknowledged (and pending) MAC PDU may have been obtained/generated, and was not successfully transmitted by the UE due to LBT failure or due to the MAC PDU being deprioritized as a result of intra-UE prioritization. Alternatively, an unacknowledged MAC PDU may have been transmitted by the UE but has not yet been acknowledged (by the network). Nevertheless, an unacknowledged (and pending) MAC PDU of a HARQ process may be considered as being acknowledged by the network upon expiration of the configuredGrantTimer for the HARQ process, upon reception of a DFI indicating an ACK for the HARQ process, upon reception of an UL grant indicating a new transmission (e.g., with toggled NDI) for the HARQ process, etc.

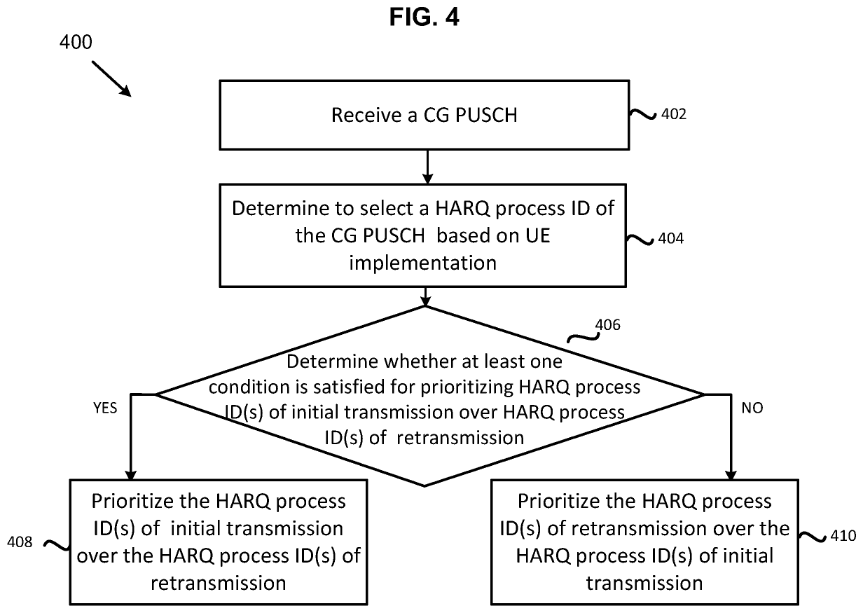

FIG. 4 illustrates a flowchart of a method by a UE for prioritizing HARQ process ID(s) of initial transmission or retransmission when selecting a HARQ process ID of a CG PUSCH in accordance with an example implementation of the present disclosure. As illustrated in flowchart 400, in action 402, a UE may receive a CG PUSCH (e.g., when a CG PUSCH becomes available for transmission). In action 404, the UE may determine to select a HARQ process ID of the CG PUSCH based on UE implementation. For example, the HARQ process ID of the CG PUSCH may be selected among the HARQ process IDs available for the configured grant configuration that the CG PUSCH corresponds or belongs to. In action 406, the UE may further determine whether to (allow) prioritize the HARQ process ID(s) of initial transmission (e.g., a new transmission) over the HARQ process ID(s) of retransmission when selecting the HARQ process ID of the CG PUSCH, and vice versa.

In action 408, the UE may prioritize the HARQ process ID(s) of initial transmission over the HARQ process ID(s) of retransmission. In one implementation, if a UE determines to prioritize the HARQ process ID(s) of initial transmission over the HARQ process ID(s) of retransmission when selecting a HARQ process ID of a CG PUSCH, the UE may select a HARQ process ID among the HARQ process ID(s) of the configured grant configuration that the CG PUSCH corresponds or belongs to and for which is available for initial transmission, if any. On the other hand, if there is no HARQ process ID(s) available for initial transmission from the configured grant configuration that the CG corresponds or belongs to, the UE may select a HARQ process ID among the HARQ process ID(s) for retransmission for the configured grant configuration that the CG PUSCH corresponds or belongs to.

In action 410, the UE may prioritize the HARQ process ID(s) of retransmission over the HARQ process ID(s) of initial transmission. In one implementation, if a UE determines to prioritize the HARQ process ID(s) of retransmission over the HARQ process ID(s) of initial transmission when selecting a HARQ process ID of a CG PUSCH, the UE may select a HARQ process ID among the HARQ process ID(s) of the configured grant configuration that the CG PUSCH corresponds or belongs to and for which is available for retransmission, if any. On the other hand, if there is no HARQ process ID(s) available for retransmission from the configured grant configuration that the CG corresponds to/belongs, the UE may select a HARQ process ID among the HARQ process ID(s) for initial transmission for the configured grant configuration that the CG PUSCH corresponds or belongs to.

Referring back to action 406, in various implementations of the present disclosure, if at least one of the conditions (e.g., conditions 1-1 to 1-5 below) is satisfied, the UE may prioritize the HARQ process ID(s) of initial transmission over the HARQ process ID(s) of retransmission (e.g., action 408) when selecting the HARQ process ID of the CG PUSCH. Otherwise, the UE may prioritize the HARQ process ID(s) of retransmission over the HARQ process ID(s) of initial transmission (e.g., action 410) when selecting the HARQ process ID of the CG PUSCH.

Condition 1-1: The Priority of (the HARQ Process ID for) Retransmission is Lower than the Priority of (the HARQ Process ID for) Initial Transmission

In some implementations, when a UE has determined to select a HARQ process ID of a CG PUSCH based on UE implementation (e.g., the UE has to select the a HARQ process ID of the CG PUSCH among the HARQ process ID(s) available for the configured grant configuration that the CG PUSCH corresponds to/belongs), the UE may prioritize the HARQ process ID(s) of initial transmission over the HARQ process ID(s) of retransmission when selecting the HARQ process ID of the CG PUSCH if the priority of (the HARQ process ID for) initial transmission is higher than the priority of (the HARQ process ID for) retransmission. In an implementation, the UE may select a HARQ process ID(s) among the HARQ process ID(s) available for initial transmission (for the configured grant configuration that the CG PUSCH corresponds to/belongs), if any (e.g., if the HARQ process ID for initial transmission is higher than the HARQ process ID for retransmission). On the other hand, the UE may select a HARQ process ID(s) among the HARQ process ID(s) for retransmission (for the configured grant configuration that the CG PUSCH corresponds to/belongs) only if there is no available HARQ process ID(s) for initial transmission (e.g., if the HARQ process ID of retransmission is higher than the HARQ process ID for initial transmission). In another implementation, if the priority of (the HARQ process ID for) initial transmission is higher than the priority of (the HARQ process ID for) retransmission, the UE may flush the HARQ buffer associated to the HARQ process ID(s) for retransmission and/or stop the configuredGrantTimer associated to the HARQ process ID(s) for retransmission and/or considers the pending MAC PDU associated to the HARQ process ID(s) for retransmission as not pending. In some implementations, if the priority of (the HARQ process ID for) initial transmission is higher than the priority of (the HARQ process ID for) retransmission, the UE discard the MAC PDU stored in the HARQ buffer associated to the retransmission.

In one implementation, the priority of (the HARQ process ID for) initial transmission may be determined by the highest priority among priorities of the MAC CEs and/or LCHs with data available that can be multiplexed in a MAC PDU to be generated and transmitted on the CG PUSCH (e.g., determined by the priority/channelAccessPriority IE configured for the MAC CE and/or LCH, determined by the MAC CE and/or LCH with the lowest configured priority/channelAccessPriority value, etc.). Moreover, such a prioritization rule may consider the mapping restriction of the MAC CE(s) and/or LCH(s). For example, a MAC CE and/or LCH that cannot be mapped to the CG PUSCH, according to mapping restriction, cannot be multiplexed in the MAC PDU for transmission on the CG PUSCH.

In one implementation, the priority of (the HARQ process ID for) retransmission may be determined by the highest priority among priorities of the generated/obtained (and pending) MAC PDU(s). In addition, the generated/obtained (and pending) MAC PDU may be intended for transmission on another CG PUSCH that arrives earlier than the PUSCH. The generated/obtained (and pending) MAC PDU(s) has not yet been acknowledged by the network and may be retransmitted or autonomously transmitted on the CG PUSCH. The HARQ process ID(s) of the generated/obtained (and pending) MAC PDU(s) may be referred to as the HARQ process ID(s) of retransmission.

In one implementation, the priority of a generated/obtained (and pending) MAC PDU may be determined by the highest priority among priorities of the MAC CEs and/or LCHs that are already multiplexed in the MAC PDU (e.g., determined by the priority/channelAccessPriority IE configured for the MAC CE and/or LCH, determined by the MAC CE and/or LCH with the lowest configured priority/channelAccessPriority value, etc.).

In one implementation, the priority/channelAccessPriority may be configured for a LCH (e.g., in the LogicalChannelConfig IE of the LCH).

In an implementation, the priority/channelAccessPriority may be configured for a MAC CE.

In an implementation, each LCH may be configured with one or more mapping restrictions (e.g., in the LogicalChannelConfig IE of the LCH).

In an implementation, each MAC CE may be configured with one or more mapping restrictions in order to map the MAC CE on certain UL resources. The MAC CE may only be transmitted on the UL resources that it is mapped to.

In an implementation, the mapping restriction may include but not limited to allowedCG-List, allowedPHY-PriorityIndex, allowedSCS-List, allowedServingCells, etc.

In one implementation, when a UE needs to select a HARQ process ID of a CG PUSCH based on UE implementation (e.g., the UE has to select the a HARQ process ID of the CG PUSCH among the HARQ process ID(s) available for the configured grant configuration that the CG PUSCH corresponds to/belongs), the UE may prioritize the HARQ process ID(s) of initial transmission over the HARQ process ID(s) of retransmission when selecting the HARQ process ID of the CG PUSCH if the delay sensitivity level for initial transmission is higher than the delay sensitivity level of retransmission. As such, the UE may select a HARQ process ID(s) among the HARQ process ID(s) available for initial transmission for the configured grant configuration (if any). On the other hand, the UE may only select a HARQ process ID(s) among the HARQ process ID(s) of the configured grant configuration for retransmission only if there is no available HARQ process ID(s) for initial transmission.

In one implementation, the delay sensitivity level of initial transmission may be determined by the lowest maxPUSCH-Duration among maxPUSCH-Duration of the MAC CEs and/or LCHs with data available that can be multiplexed in a MAC PDU to be transmitted on the CG PUSCH. In addition, such a prioritization rule may consider the mapping restriction of the MAC CE and/or LCHs. For example, a MAC CE and/or LCH that cannot be mapped to the CG PUSCH, according to mapping restriction, cannot be multiplexed in the MAC PDU for transmission.

In one implementation, the delay sensitivity level of retransmission may be determined by the lowest maxPUSCH-Duration among maxPUSCH-Duration(s) of the generated/obtained (and pending) MAC PDU(s).

In one implementation, the maxPUSCH-Duration may be configured for a LCH (e.g., in the LogicalChannelConfig IE of the LCH). In one implementation, the maxPUSCH-Duration may be configured for a MAC CE. In one implementation, the (HARQ process ID for) initial transmission may be considered as having the highest priority if a specific LCH and/or specific MAC CE and/or a specific UCI can be multiplexed in a MAC PDU for initial transmission on the CG PUSCH.

In one implementation, a generated/obtained (and pending) MAC PDU may be considered as having the highest priority if a specific LCH and/or specific MAC CE and/or a specific UCI is multiplexed in the MAC PDU.

In one implementation, the (HARQ process ID for) initial transmission may be considered as having the lowest priority if a specific LCH and/or specific MAC CE and/or a specific UCI is not available for multiplexing in a MAC PDU for initial transmission on the CG PUSCH.

In one implementation, a generated/obtained (and pending) MAC PDU may be considered as having the lowest priority if a specific LCH and/or specific MAC CE and/or a specific UCI is not multiplexed in the MAC PDU.

In one implementation, the (HARQ process ID for) initial transmission may be considered as having the lowest priority if no LCH and/or no MAC CE and/or no specific UCI is available for multiplexing in a MAC PDU for initial transmission on the CG PUSCH.

In one implementation, a generated/obtained (and pending) MAC PDU may be considered as having the lowest priority if no LCH and/or no MAC CE and/or no specific UCI is multiplexed in the MAC PDU.

In one implementation, the (HARQ process ID for) retransmission may be considered as having the lowest priority if there is no generated/obtained (and pending) MAC PDU that can be retransmitted or autonomously transmitted on the CG PUSCH.

In one implementation, if (the HARQ process ID for) initial transmission and (the HARQ process ID for) retransmission have the same priority, the UE may prioritize the HARQ process ID(s) of initial transmission over the HARQ process ID(s) of retransmission when selecting the HARQ process ID of the CG PUSCH. Alternatively, the UE may prioritize the HARQ process ID(s) of retransmission over the HARQ process ID(s) of initial transmission when selecting the HARQ process ID of the CG PUSCH. Alternatively, the UE may prioritize the HARQ process ID(s) of either retransmission or initial transmission based on UE implementation when selecting the HARQ process ID of the CG PUSCH.

In one implementation, a specific LCH may be explicitly indicated by the network (e.g., the network may indicate a specific LCH via LogicalChannelConfig).

In one implementation, a specific LCH may be preconfigured (e.g., written in specification).

In one implementation, a specific LCH may be mapped to a specific SRB (e.g., SRB0, SRB1, SRB2, or SRB3).

In one implementation, a specific LCH may be a CCCH.

In one implementation, a specific LCH may have a specific characteristic(s). For example, a specific LCH ID/LCG ID, a specific channelAccessPriority value, a specific maxPUSCH-Duration value, a LCH that is configured with configuredGrantTypelAllowed, or any combination thereof.

In one implementation, a specific MAC CE may be explicitly indicated by the network.

In one implementation, a specific MAC CE may be preconfigured (e.g., written in specification).

In one implementation, a specific MAC CE may include and is not limited to a C-RNTI MAC CE, Configured Grant Confirmation MAC CE, BFR MAC CE, Multiple Entry Configured Grant Confirmation MAC CE, Sidelink Configured Grant Confirmation MAC CE, LBT failure MAC CE, MAC CE for SL-BSR prioritized according to clause 5.22.1.6 of [6], MAC CE for BSR except BSR included for padding, Single Entry PHR MAC CE or Multiple Entry PHR MAC CE, MAC CE for the number of Desired Guard Symbols, MAC CE for Pre-emptive BSR, MAC CE for SL-BSR except SL-BSR prioritized according to clause 5.22.1.6, SL-BSR included for padding, MAC CE for Recommended bit rate query, MAC CE for BSR included for padding, MAC CE for SL-BSR included for padding, etc.

In one implementation, a specific UCI may be explicitly indicated by the network.

In one implementation, a specific UCI may be preconfigured (e.g., written in specification).

In one implementation, a specific UCI may include and is not limited to a SR, ACK/NACK, CSI-RS, etc.

In one implementation, when a UE has to select a HARQ process ID of a CG PUSCH based on UE implementation (e.g., the UE has to select the a HARQ process ID of the CG PUSCH among the HARQ process ID(s) available for the configured grant configuration that the CG PUSCH corresponds to/belongs), the UE may prioritize the HARQ process ID(s) of initial transmission over the HARQ process ID(s) of retransmission when selecting the HARQ process ID of the CG PUSCH if the phy-PriorityIndex for initial transmission is higher than the phy-PriorityIndex of retransmission. As such, the UE may select a HARQ process ID(s) among the HARQ process ID(s) available for initial transmission for the configured grant configuration, if any. On the other hand, the UE may only select a HARQ process ID(s) among the HARQ process ID(s) of the configured grant configuration for retransmission only if there is no available HARQ process ID(s) for initial transmission. Moreover, the phy-PriorityIndex for an initial transmission/retransmission may be referred to as the phy-PriorityIndex configured for configured grant configuration that the initial transmission/retransmission corresponds to.

Condition 1-2: A Specific IE has (not) been Configured to the Configured Grant Configuration that the CG PUSCH Corresponds or Belongs to

In some implementations, if a UE determines to select a HARQ process ID of a CG PUSCH based on UE implementation, the UE may prioritize the HARQ process ID(s) of initial transmission over the HARQ process ID(s) of retransmission when selecting the HARQ process ID of the CG PUSCH if at least one of (but may not be limited to) the following specific IEs has been configured (in the configured grant configuration that the CG PUSCH corresponds to/belongs) and/or at least one of the following specific IEs (but not be limited to) has not been configured (in the configured grant configuration that the CG PUSCH corresponds to/belongs). Otherwise, the UE may prioritize the HARQ process ID(s) of retransmission over the HARQ process ID(s) of initial transmission.

The specific IEs may include, but are not limited to, the following:
cg-Retransmission Timer;
configuredGrantTimer;
configuredGrantConfigIndex;
configuredGrantConfigIndexMAC;
ConfiguredGrantConfigToAddModList;
autonomousTx;
phy-PriorityIndex;
allowedCG-List;
lch-BasedPrioritization;
harq-ProcID-Offset;
harq-ProcID-Offset2;
lbt-FailureRecoveryConfig;
repK-RV.

In one implementation, the specific IE may be an IE that is configured per UE, per entity (e.g., MAC entity, RLC entity, PDCP entity, etc.). It should be noted that, in some implementations, the IE may be different from the IEs mentioned above.

In one implementation, the UE may determine whether to perform other conditions in the present disclosure (e.g., conditions 1-1, 1-3, 1-4, and 1-5) based on whether at least one of the specific IEs has been configured (in the configured grant configuration that the CG PUSCH corresponds or belongs to). If none of the specific IEs has been configured, the UE may not further determine whether at least one of the other conditions (e.g., conditions 1-1, 1-3, 1-4, 1-5) in the present disclosure is satisfied, and may prioritize the HARQ process ID(s) of retransmission over the HARQ process ID(s) of initial transmission. If at least one of the specific IEs has been configured, the UE may further determine whether at least one of the other conditions (e.g., condition 1-1, 1-3, 1-4, 1-5) in the present disclosure is satisfied. The UE may only prioritize the HARQ process ID(s) of initial transmission over the HARQ process ID(s) of retransmission if at least one of the specific IEs has been configured and at least one of the other conditions (e.g., condition 1-1, 1-3, 1-4, 1-5) in the present disclosure has been satisfied.

In one implementation, if a UE determines to select a HARQ process ID of a CG PUSCH based on UE implementation, the UE may either prioritize the HARQ process ID(s) of retransmission over the HARQ process ID(s) of initial transmission when selecting the HARQ process ID of the CG PUSCH, or vice versa, based on the value of the cg-Retransmission Timer (or the configuredGrantTimer configured in the same configured grant configuration). The UE may always prioritize the HARQ process ID(s) of retransmission over the HARQ process ID(s) of initial transmission if the value of the cg-RetransmissionTimer or the configuredGrantTimer is above a certain value (e.g., 0). In contrast, the UE may always prioritize the HARQ process ID(s) of initial transmission over the HARQ process ID(s) of retransmission if the value of the cg-RetransmissionTimer or the configuredGrantTimer is equal to a certain value (e.g., 0).

In one implementation, if a cg-Retransmission Timer is configured in a configured grant configuration (e.g., ConfiguredGrantConfig IE), a UE may derive a HARQ process ID of a CG PUSCH of the configured grant configuration based on UE implementation. Furthermore, based on the presence of specific IE(s), the UE may determine whether to prioritize the HARQ process ID(s) of initial transmission over the HARQ process ID(s) of retransmission when selecting the HARQ process ID of the CG PUSCH. If the specific IE(s) (e.g., harq-ProcID-Offset2) is not configured (in the same configured grant configuration where cg-RetransmissionTimer is configured), the UE may always prioritize the HARQ process ID(s) of retransmission over the HARQ process ID(s) of initial transmission. In contrast, if the specific IE(s) (e.g., harq-ProcID-Offset2) is configured (in the same configured grant configuration where cg-RetransmissionTimer is configured), the UE may always prioritize the HARQ process ID(s) of initial transmission over the HARQ process ID(s) of retransmission. Note that the specific IE(s) may be the IEs listed above.

Condition 1-3: A Specific Type of Channel Access Procedure (e.g., a Specific Type of LBT Category) is Used by the UE Before Performing the CG PUSCH Transmission

In some implementations, if a UE determines to derive a HARQ process ID of a CG PUSCH based on UE implementation, the UE may prioritize the HARQ process ID(s) of initial transmission over the HARQ process ID(s) of retransmission when selecting the HARQ process ID of the CG PUSCH if a specific type of channel access procedure (e.g., a specific type of LBT category) is used before performing the CG PUSCH transmission. On the other hand, the UE may prioritize the HARQ process ID(s) of retransmission over the HARQ process ID(s) of initial transmission if it is not using the specific type of channel access procedure.

In one implementation, the specific type of channel access procedure may be Type 1 or Type 2 (e.g., 2A, 2B, 2C, or 2D) Channel access procedure.

In one implementation, either the network may indicate a UE, or the UE may determine itself whether to use Type 1 channel access procedure or Type 2 channel access procedure before performing an UL transmission.

In one implementation, the UE may be an LBE device.

In one implementation, if a UE determines to derive a HARQ process ID of a CG PUSCH based on UE implementation, the UE may prioritize the HARQ process ID(s) of retransmission over the HARQ process ID(s) of initial transmission if Type 1 channel access procedure (e.g., a specific type of LBT category) is used before performing the CG PUSCH transmission. On the other hand, the UE may prioritize the HARQ process ID(s) of retransmission over the HARQ process ID(s) of initial transmission if Type 2 (e.g., 2A, 2B, 2C, or 2D) channel access procedure is used before performing the CG PUSCH transmission.

Condition 1-4: The Network and/or a UE Operates as FBE Device(s)

In some implementations, if UE determines to derive a HARQ process ID of the CG PUSCH based on UE implementation, the UE may prioritize the HARQ process ID(s) of initial transmission over the HARQ process ID(s) of retransmission when selecting the HARQ process ID of the CG PUSCH if the UE and/or its serving network operates as an FBE device(s).

In one implementation, the UE and/or the network may be considered as operating as an FBE device if the UE has been configured, by the network, channelAccessMode=SemiStaticChannelAccessConfig (e.g., ‘semistatic’ in Citation 2). Moreover, the network may configure channelAccessMode=SemiStaticChannelAccessConfig (e.g., ‘semistatic’ in Citation 2) to a UE via SIB1 or via dedicated configuration.

In one implementation, if the UE and/or the network is considered as operating as an FBE device, the UE and/or the network may act as an initiating device. The initiating device may perform FBE-specific channel access (e.g., LBT) every T_x within every two consecutive radio frames, starting from the even indexed radio frame at x×T_x, and with a maximum COT, T_y=0.95×T_x, where T_x=period IE in unit of ms. Moreover, period IE may be configured, by the network, in SemiStaticChannelAccessConfig IE via SIB1 or via dedicated configuration.

In one implementation, a channel access (e.g., LBT) may be performed by sensing the channel for at least during a sensing slot duration T_sl=9 μs.

In one implementation, if an initiating device (e.g., network or UE) has successfully acquired a channel (e.g., the channel access is successful or the channel is sensed to be idle), the initiating device (e.g., network) may share the COT (e.g., T_y) that it acquires with a responding device (e.g., UE or network).

In one implementation, if a UE and/or its serving network operates as FBE device(s), and at least one of the following characteristics has been satisfied, the UE may derive a HARQ process ID of a CG PUSCH based on UE implementation (or predefined equation/(pre)configured value), and may prioritize the HARQ process ID(s) of initial transmission over the HARQ process ID(s) of retransmission when selecting the HARQ process ID of the CG PUSCH. Otherwise, the UE may derive a HARQ process ID of the CG PUSCH based on predefined equation/(pre)configured value (or UE implementation).

The characteristics may include, but are not limited to, the following:
The network acts as an initiating device.
If the network acts as an initiating device, it implies the UE acts as a responding device.
The UE acts as an initiating device and has successfully acquired a COT.
If the UE acts as an initiating device, it implies the network acts as a responding device.

In one implementation, if a UE is able to transmit a CG PUSCH within a network-initiated COT, the UE may derive a HARQ process ID of the CG PUSCH based on UE implementation, and may prioritize the HARQ process ID(s) of initial transmission over the HARQ process ID(s) of retransmission.

In one implementation, if a UE acts as an initiating device and has successfully acquired a COT for transmitting on a CG PUSCH, the UE may derive a HARQ process ID of the CG PUSCH based on UE implementation, and may prioritize the HARQ process ID(s) of initial transmission over the HARQ process ID(s) of retransmission.

Condition 1-5: A (Pre)Defined Number of HARQ Processes is Pending/Occupied/Considered for Retransmission

In some implementations, when a UE has determined to select a HARQ process ID of a CG PUSCH based on UE implementation (e.g., the UE has to select the a HARQ process ID of the CG PUSCH among the HARQ process ID(s) available for the configured grant configuration that the CG PUSCH corresponds to/belongs), the UE may prioritize the HARQ process ID(s) of initial transmission over the HARQ process ID of retransmission when selecting the HARQ process ID of the CG PUSCH if a (pre)defined number of HARQ processes (e.g., 1) is pending/occupied/considered for retransmission (for the configured grant configuration/BWP that the CG PUSCH corresponds to/belongs). In one example, the UE may select a HARQ process ID(s) among the HARQ process ID(s) available for initial transmission (for the configured grant configuration that the CG PUSCH corresponds or belongs to), if any. On the other hand, the UE may select a HARQ process ID among the HARQ process IDs for retransmission (for the configured grant configuration that the CG PUSCH corresponds to/belongs).

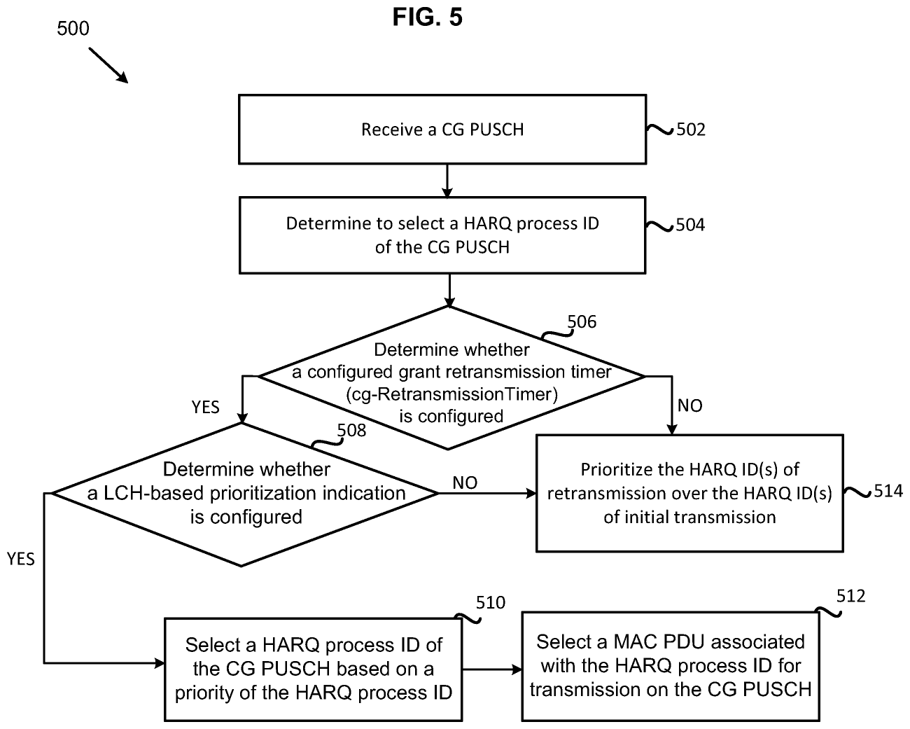

FIG. 5 illustrates a flowchart of a method by a UE for prioritizing HARQ process ID(s) of initial transmission or retransmission when selecting a HARQ process ID of a CG PUSCH in accordance with an example implementation of the present disclosure. As illustrated in flowchart 500 of FIG. 5, in action 502, a UE may receive a CG PUSCH (e.g., when a CG PUSCH becomes available for transmission). In action 504, the UE may determine to select a HARQ process ID of the CG PUSCH. The UE may determine to select a HARQ process ID of the CG PUSCH based on UE implementation. For example, the HARQ process ID of the CG PUSCH may be selected among the HARQ process IDs available for the configured grant configuration that the CG PUSCH corresponds or belongs to. In action 506, the UE may determine whether a configured grant retransmission timer (cg-RetransmissionTimer) is configured. If a cg-RetransmissionTimer is configured, then the flowchart 500 may proceed from action 506 to action 508. Otherwise, the flowchart 500 may proceed from action 506 to action 514.

In action 508, the UE may determine whether an LCH-based prioritization indication is configured. If an LCH-based prioritization indication is configured, then the flowchart 500 may proceed from action 508 to action 510. Otherwise, the flowchart 500 may proceed from action 508 to action 514.

For example, if an LCH-based prioritization indication is configured, the UE may prioritize the HARQ process ID(s) of initial transmission over the HARQ process ID(s) of retransmission (e.g., if the priority of the HARQ process ID(s) of initial transmission is higher than the priority of the HARQ process ID(s) of retransmission). Otherwise, the UE may prioritize the HARQ process ID(s) of retransmission over the HARQ process ID(s) of initial transmission.

In action 510, when an LCH-based prioritization indication is configured, the UE may select a HARQ process ID of the CG PUSCH based on a priority of the HARQ process ID. For example, the priority of the HARQ process ID may be the highest among priorities of all HARQ process IDs for the CG configuration. It should be noted that the selected HARQ process ID may be either for an initial transmission or for a retransmission.

In one implementation, the priority of the HARQ process ID is determined by an LCH with the highest LCH priority among one or more LCHs with data that is multiplexed in a MAC PDU for retransmission on the CG PUSCH, when the HARQ process ID is used for retransmission. For example, the priority of the HARQ process ID for retransmission may be determined by the highest priority among priorities of the generated/obtained (and pending) MAC PDU(s). In another implementation, the priority of the HARQ process ID is determined by an LCH with the highest LCH priority among one or more LCHs with data that can be multiplexed in a MAC PDU for transmission on the CG PUSCH, when the HARQ process ID is used for initial transmission. For example, the priority of the HARQ process ID for initial transmission may be determined by the highest priority among priorities of the MAC CEs and/or LCHs with data available that can be multiplexed in a MAC PDU to be generated and transmitted on the CG PUSCH.

In action 512, the UE may select a MAC PDU associated with the HARQ process ID for transmission on the CG PUSCH. For example, if the HARQ process ID for initial transmission is selected, the selected MAC PDU may be a newly generated MAC PDU. If the HARQ process ID for retransmission is selected, the selected MAC PDU may be a generated/obtained (and pending) MAC PDU that includes data (e.g., MAC SDU) of a LCH with the highest LCH priority among all LCH(s) with data (e.g., MAC SDU) in the generated/obtained (and pending) MAC PDUs from the CG configuration that the CG PUSCH corresponds to and/or LCH(s) with incoming data that can be transmitted on the CG configuration that the CG PUSCH corresponds to. A generated/obtained (and pending) MAC PDU from the CG configuration may be referred to as a generated/obtained (and pending) MAC PDU that was (unsuccessfully) transmitted (and/or can be transmitted) on the CG PUSCH.

In action 514, the UE may select the HARQ process ID(s) of retransmission over the HARQ process ID(s) of initial transmission.

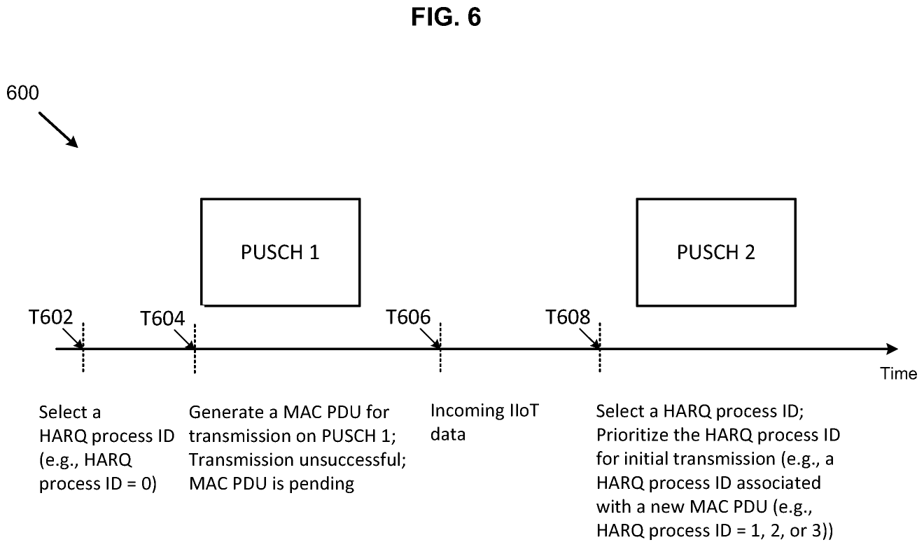

FIG. 6 illustrates a diagram of selecting a HARQ process ID of a CG PUSCH in accordance with an example implementation of the present disclosure. In FIG. 6, PUSCH 1 and PUSCH 2 belong to the same CG configuration.

As illustrated in diagram 600, at time T602, a UE may select a HARQ process ID for initial transmission (e.g., HARQ process ID=0). The selected HARQ process ID for initial transmission (e.g., HARQ process ID=0) may correspond to PUSCH 1. The UE may select the HARQ process ID from a CG configuration HARQ pool (e.g., HARQ process IDs 0, 1, 2, 3) that is configured for the current CG configuration. It is assumed that each of HARQ process ID=0, 1, 2, or 3 corresponds to the HARQ process ID for initial transmission at time T602.

At time T604, the UE may generate a MAC PDU for transmission on PUSCH 1 when CG PUSCH 1 is available. However, the transmission of the MAC PDU on PUSCH 1 may not be successful, for example, due to either an LBT failure or PUSCH 1 being deprioritized as a result of intra-UE prioritization. As a result, the MAC PDU is pending with the HARQ process ID associated with the MAC PDU being 0. Moreover, after generating the MAC PDU and/or after determining that the MAC PDU for transmission on PUSCH 1 becomes unsuccessful, the HARQ process ID=0 may be considered as a HARQ process ID for retransmission. Hence, after generating the MAC PDU and/or after determining that the MAC PDU for transmission on PUSCH 1 becomes unsuccessful, HARQ process ID=1, 2, or 3 correspond to the HARQ process ID for initial transmission.

At time T606, IIoT data arrives for transmission. The IIoT data may be delay-sensitive.

At time T608, if any of the conditions 1-1 through 1-5 described above is satisfied, the UE may select a HARQ process ID for initial transmission (e.g., HARQ process ID=1, 2, or 3). The UE may select the HARQ process ID from the CG configuration HARQ pool (e.g., HARQ process IDs 1, 2, 3) that is configured for the current CG configuration. For example, if the UE determines that at least one of an LCH-based prioritization indication and a configured grant retransmission timer (cg-Retransmission Timer) is configured, the UE may select a HARQ process ID of the CG PUSCH based on a priority of the HARQ process ID, and select a MAC PDU associated with the HARQ process ID for transmission on the CG PUSCH. In the example as illustrated in FIG. 6, the UE may prioritize the HARQ process ID(s) of initial transmission over the HARQ process ID(s) of retransmission if the priority of the HARQ process ID for initial transmission is the highest among priorities of all HARQ process IDs for the CG configuration. The priority of the HARQ process ID for retransmission (e.g., HARQ process ID=0) may be determined by the highest priority among priorities of the generated/obtained (and pending) MAC PDU(s) that was unsuccessfully transmitted on a CG PUSCH (corresponding to the CG configuration) (e.g., determined by the MAC PDU that was unsuccessfully transmitted on PUSCH 1). Moreover, the priority of each of the generated/obtained (and pending) MAC PDU may be determined by the highest priority among priorities of the LCHs that are already multiplexed in the MAC PDU (e.g., determined by the highest priority LCH being multiplexed in the MAC PDU that was unsuccessfully transmitted on PUSCH 1). The priority of the HARQ process ID for initial transmission may be determined by the highest priority among priorities of the LCHs with data available the that can be multiplexed in a MAC PDU to be generated and transmitted on the CG PUSCH (e.g., determined by the priority of the LCH where the incoming IIoT data comes from).

After the IIoT data arrives, if any of the conditions 1-1 through 1-5 described above is satisfied, the UE may generate a new MAC PDU, which includes the IIoT data, and prioritize the new MAC PDU containing the IIoT data (e.g., prioritize the HARQ process ID of initial transmission of the new MAC PDU over the HARQ process ID of retransmission of the previously pending MAC PDU. For example, the UE may select HARQ process ID 1, 2, or 3, and generate a new MAC PDU for transmission on PUSCH 2. The new MAC PDU may be generated from the incoming IIoT data. In the present implementation, it is assumed that the previously pending MAC PDU may include less delay-sensitive data (e.g., eMBB data).

As such, the newly generated MAC PDU may be transmitted on CG PUSCH 2. It is assumed that CG PUSCH 2 is valid for transmitting the newly generated MAC PDU. For example, at time T608, when the UE selects a HARQ process ID, the UE may prioritize a HARQ process ID for initial transmission over a HARQ process ID for retransmission to allow transmission of MAC PDUs having delay-sensitive data over previously pending MAC PDUs with less delay-sensitive data on a new or next available PUSCH resource. As such, implementations of the present disclosure allow the UE to consider the presence of an IE(s) to enable the selection of a HARQ process ID of a CG PUSCH based on a priority of the HARQ process ID, the content of the pending MAC PDU, and the presence of incoming data when selecting a HARQ process ID of the CG PUSCH.

Handling of Retransmission or Autonomous Transmission on a CG PUSCH

According to the mechanism in NR Rel-16 NR-U, a pending MAC PDU that was either unsuccessfully transmitted on CG PUSCH 1 or was transmitted on CG PUSCH 1 but has not yet been acknowledged by the network, may be (re)transmitted on another CG PUSCH (e.g., CG PUSCH 2). Moreover, CG PUSCH 1 and CG PUSCH 2 may correspond to the same or different configured grant configuration. As such, a UE may possibly (re)transmit the pending MAC PDU on CG PUSCH 2 even if it means CG PUSCH 1 and CG PUSCH 2 have different characteristics (e.g., TBS, PUSCH duration, MCS level, priority, etc.). This mechanism is acceptable in NR Rel-16 NR-U because high reliable and delay sensitive IIoT/URLLC data is not considered, as the impact of retransmission on a CG PUSCH with different characteristics may be ignored. Nevertheless, if considering the presence of IIoT/URLLC traffic in an unlicensed controlled environment under NR Rel-17, (re)transmission of a pending MAC PDU on a CG PUSCH with different characteristics may be conditionally allowed. For example, the UE may consider the mapping restriction of the CG PUSCH that a pending MAC PDU is (re)transmitted on and/or the content of the pending MAC PDU.

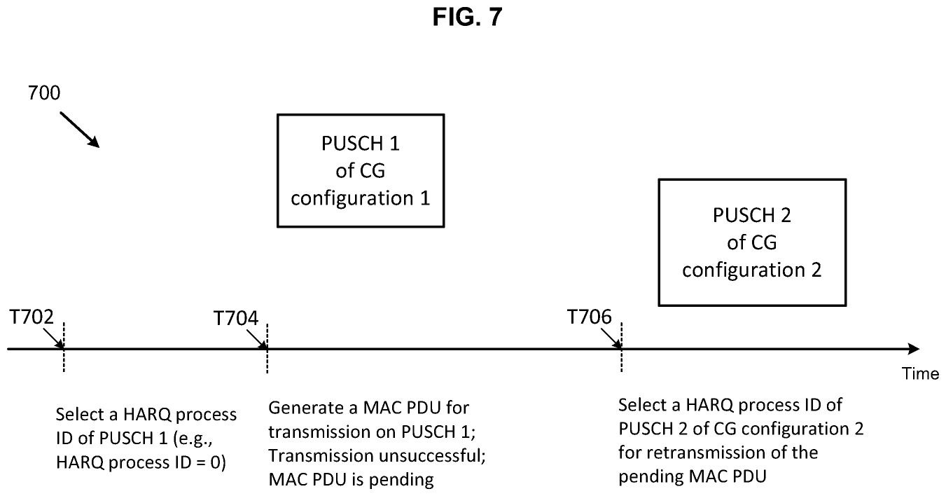

FIG. 7 illustrates a diagram of handling CG retransmission in accordance with an example implementation of the present disclosure. In FIG. 7, PUSCH 1 and PUSCH 2 belong to different CG configurations.

As illustrated in diagram 700, at time T702, a UE may select a HARQ process ID for initial transmission (e.g., HARQ process ID=0). The UE may select the HARQ process ID from a CG configuration HARQ pool (e.g., HARQ process IDs 0, 1, 2, 3) that is configured for the CG configuration 1.

At time T704, the UE may generate a MAC PDU for transmission on PUSCH 1 when CG PUSCH 1 is available. However, the transmission of the MAC PDU on PUSCH 1 may not be successful, for example, due to either LBT failure or PUSCH 1 being deprioritized as a result of intra-UE prioritization. As a result, the MAC PDU is pending with the HARQ process ID associated with the MAC PDU being 0.

At time T706, the UE may select a HARQ process ID of PUSCH 2 of CG configuration 2 for retransmission of the pending MAC PDU if at least one of the following conditions is satisfied (e.g., conditions 2-1 through 2-4 below). In the present implementation, if the UE determines that transmission of a MAC PDU using a first CG PUSCH, which corresponds to a first configured grant configuration, has not been successfully performed, the UE may perform retransmission or autonomous transmission of the MAC PDU on a second CG PUSCH, which corresponds to a second configured grant configuration different from the first configured grant configuration, if at least one of the following conditions is satisfied (e.g., conditions 2-1 to condition 2-4 below). It is noted that in the present implementation, the MAC PDU may have already been generated/obtained by the (MAC entity of the) UE when the UE determines that it has not been successfully performed.

Condition 2-1: The MAC PDU can be Mapped to the Second CG PUSCH

In one implementation, the MAC PDU may be transmitted on the second CG PUSCH if it is mapped to the second CG PUSCH.

In one implementation, the MAC PDU may be mapped to the second CG PUSCH if all the MAC CE(s) in the MAC PDU and/or all the data in the MAC PDU (e.g., all the MAC SDU(s) that are included in the MAC PDU) may be mapped to the second CG PUSCH, according to the mapping restriction defined in Citation 6.

In one implementation, the MAC PDU may be mapped to the second CG PUSCH if specific MAC CE(s) in the MAC PDU and/or data from specific LCH(s) in the MAC PDU (e.g., specific MAC SDU(s) that are included in the MAC PDU) may be mapped to the second CG PUSCH, according to the mapping restriction defined in Citation 6.

In one implementation, a specific LCH may be explicitly indicated by the network (e.g., the network may indicate a specific LCH via LogicalChannelConfig).

In one implementation, a specific LCH may be preconfigured (e.g., written in specification).

In one implementation, a specific LCH may be mapped to a specific SRB (e.g., SRB0, SRB1, SRB2, or SRB3).

In one implementation, a specific LCH may be a CCCH.

In one implementation, a specific LCH may be configured with allowedPHY-PriorityIndex (of a specific value, e.g., p0 or p1).

In one implementation, a specific LCH may have a specific characteristic(s). For example, a specific LCH ID/LCG ID, a specific channelAccessPriority value, a specific priority value, a specific maxPUSCH-Duration value, a LCH that is configured with configuredGrantTypelAllowed, or any combination thereof.

In one implementation, a specific MAC CE may be explicitly indicated by the network.

In one implementation, a specific MAC CE may be preconfigured (e.g., written in specification).

In one implementation, a specific MAC CE may include and is not limited to a C-RNTI MAC CE, Configured Grant Confirmation MAC CE, BFR MAC CE, Multiple Entry Configured Grant Confirmation MAC CE, Sidelink Configured Grant Confirmation MAC CE, LBT failure MAC CE, MAC CE for SL-BSR prioritized according to clause 5.22.1.6 of [6], MAC CE for BSR except BSR included for padding, Single Entry PHR MAC CE or Multiple Entry PHR MAC CE, MAC CE for the number of Desired Guard Symbols, MAC CE for Pre-emptive BSR, MAC CE for SL-BSR except SL-BSR prioritized according to clause 5.22.1.6, SL-BSR included for padding, MAC CE for Recommended bit rate query, MAC CE for BSR included for padding, MAC CE for SL-BSR included for padding, etc.

In one implementation, each LCH may be configured with one or more mapping restrictions (e.g., in the LogicalChannelConfig IE of the LCH).

In one implementation, each LCH may be configured with one or more mapping restrictions in order to map the MAC CE on certain UL resources. The MAC CE may only be transmitted on the UL resources that it is mapped to.

In one implementation, the mapping restriction may include but not limited to allowedCG-List, allowedPHY-PriorityIndex, allowedSCS-List, allowedServingCells, etc.

Condition 2-2: The MAC PDU is Referred to as a Specific MAC PDU

In some implementations, the MAC PDU may be referred to as a specific MAC PDU if it (does not) includes data from a specific LCH and/or it (does not) includes a specific MAC CE.

In one implementation, the MAC PDU may be referred to as a MAC PDU if it (does not) includes MAC SDU from a LCH associated with an SRB.

In one example, if a UE determines that transmission of a MAC PDU using a first CG PUSCH, which corresponds to a first configured grant configuration, has not been successfully performed, the UE may perform retransmission or autonomous transmission of the MAC PDU on a second CG PUSCH, which corresponds to a second configured grant configuration different from the first configured grant configuration, only if the MAC PDU is referred to as a specific MAC PDU (e.g., the MAC PDU that (does not) includes a specific MAC CE(s) and/or data from a specific LCH(s)). Otherwise, the UE may not perform (re)transmission of the MAC PDU on the second CG PUSCH.

Condition 2-3: A Specific IE has been Configured (to a Certain Value) in the First and/or Second Configured Grant Configuration

In some implementations, the specific IEs may include, but are not limited to, the following:
cg-Retransmission Timer;
configuredGrantTimer;
configuredGrantConfigIndex;
configuredGrantConfigIndexMAC;
ConfiguredGrantConfigToAddModList;
autonomousTx;
phy-PriorityIndex;
allowedCG-List;
lch-BasedPrioritization;
harq-ProcID-Offset;
harq-ProcID-Offset2;
lbt-FailureRecoveryConfig;
repK-RV.

In one implementation, if a UE determines that transmission of a MAC PDU using a first CG PUSCH, which corresponds to a first configured grant configuration, has not been successfully performed, the UE may perform retransmission or autonomous transmission of the MAC PDU on a second CG PUSCH, which corresponds to a second configured grant configuration different from the first configured grant configuration, if cg-RetransmissionTimer and/or harq-ProcID-Offset2 are both configured in the second (and/or first) configured grant configuration. Otherwise, the UE may not perform (re)transmission of the MAC PDU on the second CG PUSCH.

In one implementation, if a UE determines that transmission of a MAC PDU using a first CG PUSCH, which corresponds to a first configured grant configuration, has not been successfully performed, the UE may perform retransmission or autonomous transmission of the MAC PDU on a second CG PUSCH, which corresponds to a second configured grant configuration different from the first configured grant configuration, if the value of the cg-Retransmission Timer or the configuredGrantTimer configured for the first and/or second configured grant configuration is equal to a certain value (e.g., 0). Otherwise, the UE may not perform (re)transmission of the MAC PDU on the second CG PUSCH.

In one implementation, if a UE determines that transmission of a MAC PDU using a first CG PUSCH, which corresponds to a first configured grant configuration, has not been successfully performed, the UE may perform retransmission or autonomous transmission of the MAC PDU on a second CG PUSCH, which corresponds to a second configured grant configuration different from the first configured grant configuration, if the UE is able to derive the HARQ process ID of the first and/or second CG PUSCH based on UE implementation. In contrast, if the mechanism to derive the HARQ process ID of the second CG PUSCH is different from the mechanism to derive the HARQ process ID of the first CG PUSCH is (e.g., the HARQ process ID of the first CG PUSCH is derived based on UE implementation and the HARQ process ID of the second CG PUSCH is derived based on a predefined equation), the UE may not perform (re)transmission of the MAC PDU on the second CG PUSCH.

In one implementation, a UE may determine to derive the HARQ process ID of the first and/or second CG PUSCH based on UE implementation via the embodiment as shown above.

In one implementation, if a UE determines that transmission of a MAC PDU using a first CG PUSCH, which corresponds to a first configured grant configuration, has not been successfully performed, the UE may perform retransmission or autonomous transmission of the MAC PDU on a second CG PUSCH, which corresponds to a second configured grant configuration different from the first configured grant configuration, if one or multiple specific IE(s) as mentioned above (e.g., cg-RetransmissionTimer and/or harq-ProcID-Offset2) is configured in both the first configured grant configuration and the second configured grant configuration. Otherwise, the UE may not perform (re)transmission of the MAC PDU on the second CG PUSCH.

In one implementation, if a UE determines that transmission of a MAC PDU using a first CG PUSCH, which corresponds to a first configured grant configuration, has not been successfully performed, the UE may perform retransmission or autonomous transmission of the MAC PDU on a second CG PUSCH, which corresponds to a second configured grant configuration different from the first configured grant configuration, if one or multiple specific IE(s) as mentioned above (e.g., repK, periodicity, MCS-table, repK-RV, and/or phy-PriorityIndex) is configured to the same value in both the first configured grant configuration and the second configured grant configuration. Otherwise, the UE may not perform (re)transmission of the MAC PDU on the second CG PUSCH.

In one implementation, if a UE determines that transmission of a MAC PDU using a first CG PUSCH, which corresponds to a first configured grant configuration, has not been successfully performed, the UE may perform retransmission or autonomous transmission of the MAC PDU on a second CG PUSCH, which corresponds to a second configured grant configuration different from the first configured grant configuration, if at least one of the following conditions is satisfied. Otherwise, the UE may not perform (re)transmission of the MAC PDU on the second CG PUSCH.

In some implementations, the conditions may include, but are not limited to the following:
periodicity configured for the second configured grant configuration is smaller than the periodicity configured for the first configured grant configuration;
first configured grant configuration is configured with phy-PriorityIndex of low priority and second configured grant configuration is configured with phy-PriorityIndex of high priority or is not configured with phy-PriorityIndex;
first configured grant configuration is not configured with phy-PriorityIndex and second configured grant configuration is configured with phy-PriorityIndex of high/low priority;
first configured grant configuration is configured with phy-PriorityIndex and second configured grant configuration is configured with phy-PriorityIndex of high/low priority.

In one implementation, if a UE determines that transmission of a MAC PDU using a first CG PUSCH, which corresponds to a first configured grant configuration, has not been successfully performed, the UE may perform retransmission or autonomous transmission of the MAC PDU on a second CG PUSCH if there is no other generated/obtained (and pending) MAC PDU with higher priority than the first MAC PDU, and for which is suitable for transmission on the second CG PUSCH. Otherwise, the UE may not perform (re)transmission of the MAC PDU on the second CG PUSCH.

In one implementation, the priority of a MAC PDU may be determined by the highest priority among priorities of the MAC CEs and/or LCHs with data available that can be multiplexed in the MAC PDU to be transmitted on the CG PUSCH (e.g., determined by the priority/channelAccessPriority IE configured for the MAC CE and/or LCH, determined by the MAC CE and/or LCH with the lowest configured priority/channelAccessPriority value, etc.).

Condition 2-4: The Second CG PUSCH is Scheduled/Configured at Least at a Period, T_retransmission, after the First CG PUSCH

In some implementations, the starting/ending symbol (or slot) of the second CG PUSCH is scheduled at least a period, T_retransmission, after the starting/ending symbol (or slot) of the first CG PUSCH.

In one implementation, T_retransmission may be preconfigured (e.g., written in spec).

In one implementation, T_retransmission may be configured by the network via DCI, MAC CE, or RRC signaling.

In one implementation, the value of T_retransmission may be determined based on a preconfigured lookup table (e.g., Table 6.4-1 or 6.4-2 of Citation 3). The lookup table may map different T_retransmission values to different UL subcarrier spacing (SCS) corresponding to the indicated PUSCH duration/different DL SCS corresponding to the PDCCH scheduling the PUSCH duration. Moreover, different lookup tables may be used for UE with different UE processing capability.

In one implementation, the value of T_retransmission may include the PUSCH preparation time.

In one implementation, the value of T_retransmission may be in symbols, slots, milliseconds, etc.

In one implementation, the network may configure an offset (e.g., harq-procID-Offset or harq-procID-Offset2) to a UE if at least one of the conditions as described above (e.g., condition 2-1 to condition 2-4) are satisfied. As such, the network may avoid the UE from performing (re)transmission of a pending MAC PDU on a CG PUSCH that corresponds to a different configured grant configuration from the CG PUSCH where the MAC PDU was intended for.

In one implementation, the network may configure a UE more than one configured grant configurations in the same BWP with overlapping HARQ process ID(s) (e.g., the HARQ process ID may be selected by a UE in the PUSCHs of the more than one configured grant configurations). However, network may need to configure specific IEs (to identical values) in the more than one configured grant configurations. In one implementation, the specific IEs may include, but are not limited to the following:
cg-Retransmission Timer;
configuredGrantTimer;
configuredGrantConfigIndex;
configuredGrantConfigIndexMAC;
autonomousTx;
phy-PriorityIndex;
allowedCG-List;
lch-BasedPrioritization;
harq-ProcID-Offset;
harq-ProcID-Offset2;
lbt-FailureRecoveryConfig;
repK-RV;
repK;
cg-nrofPUSCH-InSlot-r16;
cg-nrofSlots-r16 INTEGER;
cg-StartingOffsets-r16;
cg-UCI-Multiplexing;
cg-COT-SharingOffset-r16;
betaOffsetCG-UCI-r16;
cg-COT-SharingList-r16;
harq-ProcID-Offset-r16;
harq-ProcID-Offset2-r16;
mcs-Table;
nrofHARQ-Processes;
periodicity;
timeDomainOffset;
timeDomainAllocation;
frequencyDomainAllocation.

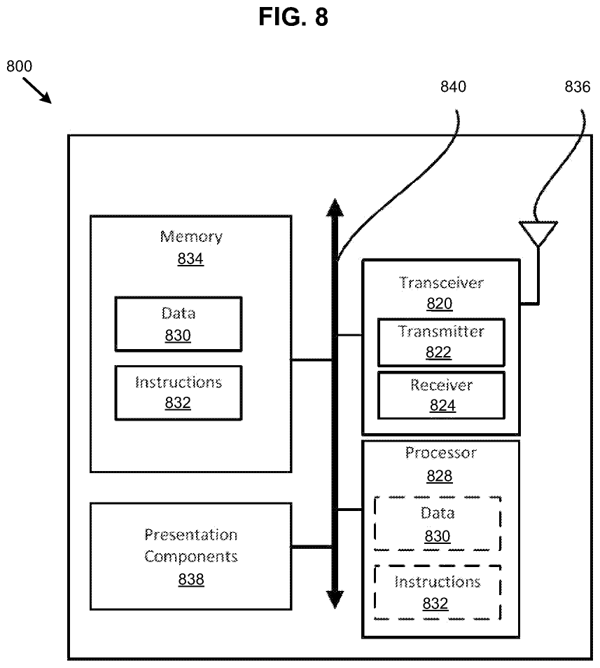

FIG. 8 is a block diagram illustrating a node for wireless communication in accordance with various aspects of the present disclosure. As illustrated in FIG. 8, a node 800 may include a transceiver 820, a processor 828, a memory 834, one or more presentation components 838, and at least one antenna 836. The node 800 may also include a radio frequency (RF) spectrum band module, a BS communications module, a network communications module, and a system communications management module, Input/Output (I/O) ports, I/O components, and a power supply (not illustrated in FIG. 8).

Each of the components may directly or indirectly communicate with each other over one or more buses 840. The node 800 may be a UE or a BS that performs various functions disclosed with reference to FIGS. 1 through 7.

The transceiver 820 has a transmitter 822 (e.g., transmitting/transmission circuitry) and a receiver 824 (e.g., receiving/reception circuitry) and may be configured to transmit and/or receive time and/or frequency resource partitioning information. The transceiver 820 may be configured to transmit in different types of subframes and slots including but not limited to usable, non-usable and flexibly usable subframes and slot formats. The transceiver 820 may be configured to receive data and control channels.

The node 800 may include a variety of computer-readable media. Computer-readable media may be any available media that may be accessed by the node 800 and include both volatile and non-volatile media, and removable and non-removable media.

The computer-readable media may include computer storage media and communication media. Computer storage media may include both volatile and non-volatile media, and removable and non-removable media implemented in any method or technology for storage of information such as computer-readable instructions, data structures, program modules or data.

Computer storage media may include RAM, ROM, EPROM, EEPROM, flash memory or other memory technology, CD-ROM, Digital Versatile Disks (DVD) or other optical disk storage, magnetic cassettes, magnetic tape, magnetic disk storage or other magnetic storage devices. Computer storage media may not include a propagated data signal. Communication media may typically embody computer-readable instructions, data structures, program modules or other data in a modulated data signal such as a carrier wave or other transport mechanism and include any information delivery media.

The term “modulated data signal” means a signal that has one or more of its characteristics set or changed in such a manner as to encode information in the signal. Communication media may include wired media such as a wired network or direct-wired connection, and wireless media such as acoustic, RF, infrared and other wireless media. Combinations of any of the previously listed components should also be included within the scope of computer-readable media.

The memory 834 may include computer-storage media in the form of volatile and/or non-volatile memory. The memory 834 may be removable, non-removable, or a combination thereof. Example memory may include solid-state memory, hard drives, optical-disc drives, etc. As illustrated in FIG. 8, the memory 834 may store computer-readable, computer-executable instructions 832 (e.g., software codes) that are configured to cause the processor 828 to perform various functions disclosed herein, for example, with reference to FIGS. 1 through 7. Alternatively, the instructions 832 may not be directly executable by the processor 828 but be configured to cause the node 800 (e.g., when compiled and executed) to perform various functions disclosed herein.

The processor 828 (e.g., having processing circuitry) may include an intelligent hardware device, e.g., a Central Processing Unit (CPU), a micro-controller, an ASIC, etc. The processor 828 may include memory. The processor 828 may process the data 830 and the instructions 832 received from the memory 834, and information transmitted and received via the transceiver 820, the baseband communications module, and/or the network communications module. The processor 828 may also process information to be sent to the transceiver 820 for transmission via the antenna 836 to the network communications module for transmission to a core network.

One or more presentation components 838 may present data indications to a person or another device. Examples of presentation components 838 may include a display device, a speaker, a printing component, and a vibrating component, etc.

In various implementations of the present disclosure, a network may be a fixed station or base station used for communicating with the terminals and may also be referred to as an access point, a Node B, a base station, an enhanced base station, an eNodeB, a gNodeB (gNB), or some other terminology.

In various implementations of the present disclosure, an unlicensed environment may be referred to as a shared spectrum, an unlicensed spectrum, and/or an unlicensed band, a cell that operates with shared spectrum channel access, etc.

In various implementations of the present disclosure, the CC may be PCell, PSCell, and/or SCell.

In various implementations of the present disclosure, the SpCell may include PCell and PSCell.

In various implementations of the present disclosure, the UL resource may be PRACH resource, PUCCH resource, and/or PUSCH resource. The UL resource may be scheduled by dynamic grant (e.g., via PDCCH) and/or configured by RRC (e.g., type 1/type 2 configured UL grant or pre-configured in RRC configuration). When a beam failure (of an SCell(s)) is detected, the UE may trigger a BFR procedure (for an SCell(s)).

In various implementations of the present disclosure, the MAC entity may be referred to the UE.

In various implementations of the present disclosure, intra-UE prioritization may be needed by a UE if two or more UL resources (scheduled/configured in the same serving cell) overlap in the time domain. As a result of intra-UE prioritization, the UE may select one of the overlapping UL resources for transmission. The selected UL resource may be referred to as a prioritized UL resource, and the MAC PDU/TB to be transmitted on the UL resource may be referred to as a prioritized MAC PDU/TB. In contrast, the UL resource(s) that is not selected may be referred to as a deprioritized UL resource(s), and the MAC PDU(s)/TB(s) to be transmitted on the deprioritized UL resource(s) may be referred to as a deprioritized MAC PDU(s)/TB(s).

In various implementations of the present disclosure, the overlap of the resource may mean partially overlap and/or fully overlap.

In various implementations of the present disclosure, the configured grant configuration may be (but is not limited to) configured grant Type 1 or configured grant Type 2.

In various implementations of the present disclosure, a MAC PDU may be referred to as a TB.

In various implementations of the present disclosure, there are two types of transmission without dynamic grant: configured grant Type 1 where an uplink grant is provided by RRC, and stored as configured uplink grant; and configured grant Type 2 where an uplink grant is provided by PDCCH, and stored or cleared as configured uplink grant based on L1 signaling indicating configured uplink grant activation or deactivation.

In various implementations of the present disclosure, an SpCell may include PCell and PSCell.

In various implementations of the present disclosure, a UL resource may be a PRACH resource, a PUCCH resource, and/or a PUSCH resource. The UL resource may be scheduled by dynamic grant (e.g., via PDCCH) and/or configured by RRC (e.g., type 1/type 2 configured UL grant or pre-configured in RRC configuration).

In various implementations of the present disclosure, a configured uplink grant may be referred to as a PUSCH resource that corresponds to a configured grant configuration.

In various implementations of the present disclosure, a CG PUSCH may be referred to as a PUSCH that corresponds to a configured grant configuration.

In various implementations of the present disclosure, a HARQ-ACK may be either an ACK or a NACK.

In various implementations of the present disclosure, a UE may consider a generated MAC PDU/TB as being obtained.

In various implementations of the present disclosure, a Frame Based Equipment may implement a Listen Before Talk (LBT) based Channel Access Mechanism to detect the presence of other RLAN transmissions on an Operating Channel.

In various implementations of the present disclosure, intra-UE prioritization may be needed by a UE if two or more UL resources (scheduled/configured in the same serving cell) that overlap in the time domain. As a result of intra-UE prioritization, the UE may select one, out of the overlapping UL resources, for transmission. The selected UL resource may be referred to as the prioritized UL resource, and the MAC PDU/TB to be transmitted on the UL resource may be referred to as the prioritized MAC PDU/TB. In contrast, the UL resource(s) that are not selected may be referred to as the deprioritized UL resource(s), and the MAC PDU(s)/TB(s) to be transmitted on the deprioritized UL resource(s) may be referred to as the deprioritized MAC PDU(s)/TB(s).

In various implementations of the present disclosure, either the network may indicate a UE, or the UE may determine itself whether to use Type 1 channel access procedure or Type 2 channel access procedure before performing an UL transmission. Specifically, type 2 channel access procedure may be further classified into Type 2A, Type 2B, Type 2C, and Type 2D channel access procedure as described in Citation 2.

In various implementations of the present disclosure, a channel occupancy initiated by an initiating device (e.g., gNB) and shared with a responding device (e.g., UE) may satisfy the following:
The initiating device (e.g., gNB) shall transmit a DL (or UL) transmission burst(s) starting at the beginning of the COT immediately after performing channel access and senses the channel to be idle for at least a sensing slot duration T_sl=9 μs. If the channel is sensed to be busy (after performing channel access), the initiating device (e.g., gNB) shall not perform any transmission during the current COT.
The initiating device (e.g., gNB) may transmit a DL (or UL) transmission burst(s) within the COT immediately after performing channel access and senses the channel to be idle for at least a sensing slot duration T_sl=9 μs if the gap between the DL (or UL) transmission burst(s) and any previous transmission burst is more than 16 μs.
The initiating device (e.g., gNB) may transmit DL (or UL) transmission burst(s) after UL (or DL) transmission burst(s) within the COT without performing channel access/sensing the channel if the gap between the DL (or UL) and UL (or DL) transmission bursts is at most 16 μs.
A responding device (e.g., UE) may transmit UL (or DL) transmission burst(s) after detection of a DL (or UL) transmission burst(s) within the COT (acquired by the initiating device) as follows:
   If the gap between the UL (or DL) and DL (or UL) transmission bursts is at most 16 μs, the responding device (e.g., UE) may transmit UL (or DL) transmission burst(s) after a DL (or UL) transmission burst(s) within the COT (acquired by the initiating device) without performing channel access/sensing the channel.
   If the gap between the UL (or DL) and DL (or UL) transmission bursts is more than 16 μs, the responding device (e.g., UE) may transmit UL (or DL) transmission burst(s) after a DL (or UL) transmission burst(s) within the COT (acquired by the initiating device) after performing channel access and senses the channel to be idle for at least a sensing slot duration T_sl=9 μs within a 25 μs interval ending immediately before transmission.
The initiating device (e.g., gNB) and responding devices (e.g., UEs) shall not transmit any transmissions in a set of consecutive symbols for a duration of at least T_z=max (0.05T_x, 100 μs) before the start of the next COT.
If a UE fails to access the channel(s) (e.g., LBT failure) prior to an intended UL transmission to a network, Layer 1 (e.g., PHY) notifies higher layers (e.g., MAC) about the channel access failure (e.g., by sending a LBT failure indication).
In one implementation, if a UE selects a HARQ process ID of a CG PUSCH via UE implementation, the UE may need to inform the network the selected HARQ process ID of a CG PUSCH (via CG-UCI). In one implementation, the UE may toggle the NDI in the CG-UCI for new transmissions and may not toggle the NDI in the CG-UCI in retransmissions.
When cg-Retransmission Timer is configured and the HARQ entity obtains a MAC PDU to transmit, the corresponding HARQ process is considered to be pending. For a configured uplink grant, configured with cg-Retransmission Timer, each associated HARQ process is considered as not pending when any of the following conditions is satisfied:
   A transmission is performed on that HARQ process and LBT failure indication is not received from lower layers;
   The configured uplink grant is initialized and this HARQ process is not associated with another active configured uplink grant;
   A HARQ buffer for this HARQ process is flushed.
In one implementation, a HARQ process ID (of a configured grant configuration) may be considered for retransmission if either one of the following conditions is satisfied:
   configuredGrantTimer of the HARQ process ID is running (and the HARQ process is pending/not pending);
   configuredGrantTimer for the HARQ process ID is not running and the HARQ process is pending.

In various implementations of the present disclosure, a HARQ process (of a configured grant configuration) may be considered for new transmission (e.g., initial transmission) if the configuredGrantTimer of the HARQ process ID is not running (and the HARQ process ID is not pending).

In various implementations of the present disclosure, a MAC entity (or HARQ entity) may be referred to the UE.

In various implementations of the present disclosure, a PCell LBT recovery procedure and/or a PSCell LBT recovery procedure may also be termed as a SpCell LBT recovery procedure.

In various implementations of the present disclosure, any two or more of the implementations, paragraphs, (sub)-bullets, points, actions, behaviors, terms, or claims may be combined logically, reasonably, and properly to form a specific method.

In the present disclosure, any sentences, paragraphs, (sub)-bullets, points, actions, behaviors, terms, or claims may be implemented independently and separately to form a specific method.

In the present disclosure, dependency (e.g., “based on”, “more specifically”, “preferably”, “in one embodiment”, “in one implementation”, or etc.) may refer to a possible example which would not restrict any specific method.

In view of the disclosure, it is obvious that various techniques may be used for implementing the concepts in the present disclosure without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are to be considered in all respects as illustrative and not restrictive. It should also be understood that the present disclosure is not limited to the particular implementations disclosed and many rearrangements, modifications, and substitutions are possible without departing from the scope of the present disclosure.

What is claimed is:

1. A method performed by a user equipment (UE) for transmission on a configured grant (CG) Physical Uplink Shared Channel (PUSCH) corresponding to a CG configuration, the method comprising:
determining whether a logical channel (LCH)-based prioritization indication is configured;
when the LCH-based prioritization indication is configured, selecting a Hybrid Automatic Repeat Request (HARQ) process identifier (ID) of the CG PUSCH based on a priority of the HARQ process ID.

2. The method of claim 1, wherein the HARQ process ID is used for initial transmission.

3. The method of claim 1, wherein the HARQ process ID is used for retransmission.

4. The method of claim 1, wherein the priority of the HARQ process ID is the highest among priorities of all HARQ process IDs for the CG configuration.

5. The method of claim 4, wherein the priority of the HARQ process ID is determined by an LCH with the highest LCH priority among one or more LCHs with data that is multiplexed in a Medium Access Control (MAC) protocol data unit (PDU) for retransmission on the CG PUSCH, when the HARQ process ID is used for retransmission.

6. The method of claim 4, wherein the priority of the HARQ process ID is determined by an LCH with the highest LCH priority among one or more LCHs with data that can be multiplexed in a Medium Access Control (MAC) protocol data unit (PDU) for transmission on the CG PUSCH, when the HARQ process ID is used for initial transmission.

7. The method of claim 1, further comprising:
selecting a Medium Access Control (MAC) protocol data unit (PDU) associated with the HARQ process ID for transmission on the CG PUSCH.

8. The method of claim 1, further comprising:
when the LCH-based prioritization indication is not configured, prioritizing a HARQ process ID for retransmission over a HARQ process ID for initial transmission.

9. The method of claim 1, wherein the transmission on the CG PUSCH is on an unlicensed frequency band.

10. The method of claim 1, further comprising:
determining whether a configured grant retransmission timer (cg-RetransmissionTimer) is configured;
wherein selecting the HARQ process ID of the CG PUSCH based on the priority of the HARQ process ID is performed, when the cg-RetransmissionTimer and the LCH-based prioritization indication are configured.

11. A user equipment (UE) for transmission on a configured grant (CG) Physical Uplink Shared Channel (PUSCH) corresponding to a CG configuration, the UE comprising:
one or more non-transitory computer-readable media containing computer-executable instructions embodied therein; and
at least one processor coupled to the one or more non-transitory computer-readable media, the at least one processor configured to execute the computer-executable instructions to:
determine whether a logic channel (LCH)-based prioritization indication is configured;
when the LCH-based prioritization indication is configured, select a Hybrid Automatic Repeat Request (HARQ) process identifier (ID) of the CG PUSCH based on a priority of the HARQ process ID.

12. The UE of claim 11, wherein the HARQ process ID is used for initial transmission.

13. The UE of claim 11, wherein the HARQ process ID is used for retransmission.

14. The UE of claim 11, wherein the priority of the HARQ process ID is the highest among priorities of all HARQ process IDs for the CG configuration.

15. The UE of claim 14, wherein the priority of the HARQ process ID is determined by an LCH with the highest LCH priority among one or more LCHs with data that is multiplexed in a Medium Access Control (MAC) protocol data unit (PDU) for retransmission on the CG PUSCH, when the HARQ process ID is used for retransmission.

16. The UE of claim 14, wherein the priority of the HARQ process ID is determined by an LCH with the highest LCH priority among one or more LCHs with data that can be multiplexed in a Medium Access Control (MAC) protocol data unit (PDU) for transmission on the CG PUSCH, when the HARQ process ID is used for initial transmission.

17. The UE of claim 11, wherein the at least one processor is further configured to execute the computer-executable instructions to:
select a Medium Access Control (MAC) protocol data unit (PDU) associated with the HARQ process ID for transmission on the CG PUSCH.

18. The UE of claim 11, wherein the at least one processor is further configured to execute the computer-executable instructions to:
when the LCH-based prioritization indication is not configured, prioritize a HARQ process ID for retransmission over a HARQ process ID for initial transmission.

19. The UE of claim 11, wherein the transmission on the CG PUSCH is on an unlicensed frequency band.

20. The UE of claim 11, wherein the at least one processor is further configured to execute the computer-executable instructions to:
determine whether a configured grant retransmission timer (cg-RetransmissionTimer) is configured;
wherein the selection of the HARQ process ID of the CG PUSCH based on the priority of the HARQ process ID is performed, when the cg-RetransmissionTimer and the LCH-based prioritization indication are configured.
